(19) United States
(12) Patent Application Publication
(10) Pub. No.: US 2026/0360819 A1
(43) Pub. Date: Nov. 12, 2026

(54) A SECONDARY BATTERY AND ELECTRONIC DEVICE

(71) Applicant: NINGDE AMPEREX TECHNOLOGY LIMITED, Ningde (CN)

(72) Inventors: Shan ZHANG, Ningde (CN); Lilan ZHANG, Ningde (CN); Xiangling ZHENG, Ningde (CN); Chao TANG, Ningde (CN)

(73) Assignee: NINGDE AMPEREX TECHNOLOGY LIMITED, Ningde (CN)

(21) Appl. No.: 19/699,771

(22) Filed: Jun. 5, 2026

Related U.S. Application Data
(63) Continuation of application No. PCT/CN2023/137111, filed on Dec. 7, 2023.

(51) Int. Cl. H01M 10/0569; H01M 4/525; H01M 10/0567; H01M 10/42

(52) U.S. Cl. CPC H01M 10/0569; H01M 4/525; H01M 10/0567; H01M 10/4235; H01M 2300/0034; H01M 2300/0037

(57) ABSTRACT

A secondary battery includes a positive electrode plate, a negative electrode plate, and an electrolyte. The positive electrode plate includes a positive electrode material layer. The positive electrode material layer includes a positive electrode active material. The positive electrode active material includes element cobalt and element magnesium. Based on a mass of the positive electrode material layer, a mass percentage of element magnesium is A %, satisfying 0.1≤A≤5. The electrolyte includes a fluorinated solvent. The fluorinated solvent includes at least one of a compound represented by formula (I), a compound represented by formula (II), a compound represented by formula (III), or a compound represented by formula (IV). Based on a mass of the electrolyte, a mass percentage of the fluorinated solvent is B %, satisfying 41.7≤B≤83.2 and 0.1≤100A/B≤6.

### CROSS REFERENCE TO RELATED APPLICATION

This application is a continuation application of International Application No. PCT/CN2023/137111, filed on Dec. 7, 2023, the contents of which are incorporated herein by reference in its entirety.

### TECHNICAL FIELD

This application relates to the field of electrochemical technologies, and in particular, to a secondary battery and an electronic apparatus.

### BACKGROUND

Secondary batteries, such as lithium-ion batteries, have advantages such as high specific energy density, light weight, and long cycle life, and therefore are widely used in consumer batteries.

With the development of electronic products toward lighter and thinner designs and portability, increasing a charge cut-off voltage of lithium-ion batteries can greatly improve energy density, but the lithium-ion batteries face higher challenges in high-temperature storage performance and high-temperature cycling performance.

### SUMMARY

This application is intended to provide a secondary battery and an electronic apparatus to improve high-temperature storage performance and high-temperature cycling performance of the secondary battery. Specific technical solutions are as follows:

A first aspect of this application provides a secondary battery, including a positive electrode plate, a negative electrode plate, and an electrolyte, where the positive electrode plate includes a positive electrode material layer, the positive electrode material layer includes a positive electrode active material, the positive electrode active material includes element cobalt and element magnesium, and based on a mass of the positive electrode material layer, a mass percentage of element magnesium is A %, satisfying 0.1≤A≤5, preferably 0.5≤A≤3. For example, the value of A may be 0.1, 0.2, 0.3, 0.5, 1, 1.5, 2, 2.5, 3, 3.5, 4, 4.5, 5, or in a range defined by any two of the above values. The electrolyte includes a fluorinated solvent, where the fluorinated solvent includes at least one of a compound represented by formula (I), a compound represented by formula (II), a compound represented by formula (III), or a compound represented by formula (IV):

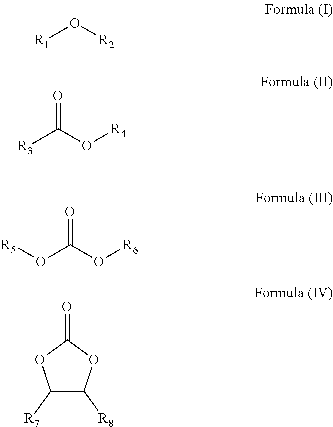

R₁ and R₂ are each independently selected from C₁ to C₅ alkyl group substituted or unsubstituted by fluorine, C₂ to C₅ alkenyl group substituted or unsubstituted by fluorine, C₂ to C₅ alkynyl group substituted or unsubstituted by fluorine, C₂ to C₅ alkyl group substituted by sulfonic acid group, or C₂ to C₅ alkyl group substituted by cyano group; R₃ to R₈ are each independently selected from H, F, C₁ to C₅ alkyl group substituted or unsubstituted by fluorine, C₂ to C₅ alkenyl group substituted or unsubstituted by fluorine, C₂ to C₅ alkynyl group substituted or unsubstituted by fluorine, C₂ to C₅ alkyl group substituted by sulfonic acid group, or C₂ to C₅ alkyl group substituted by cyano group; and at least one of R₁ and R₂ contains at least one fluorine atom, at least one of R₃ and R₄ contains at least one fluorine atom, at least one of R₅ and R₆ contains at least one fluorine atom, and at least one of R₇ and R₈ contains at least one fluorine atom. Based on a mass of the electrolyte, a mass percentage of the fluorinated solvent is B %, satisfying 41.7≤B≤83.2, preferably 45.9≤B≤75, and 0.1≤100A/B≤6. For example, the value of B may be 41.7, 43, 45, 45.9, 50, 55, 60, 65, 70, 75, 80, 83.2, or in a range defined by any two of the above values, and the value of 100A/B may be 0.1, 0.2, 0.3, 0.5, 1, 1.5, 2, 2.5, 3, 3.5, 4, 4.5, 5, 5.5, 6, or in a range defined by any two of the above values.

In the secondary battery provided in this application, the positive electrode active material includes element cobalt and element magnesium, and the mass percentage of element magnesium is regulated within the above range, which can improve stability of the positive electrode active material, thereby improving high-temperature storage performance and high-temperature cycling performance of the secondary battery. In addition, the electrolyte includes a fluorinated solvent and has its mass percentage B % regulated within the above range. On one hand, due to the high percentage of the fluorinated solvent, a high percentage of fluorine-containing interface protective film can be formed in situ on a surface of the positive electrode plate in charge-discharge cycles, and this process continues during the charge-discharge cycle process, thus continuously alleviating the problem of dissolution of transition metals from the positive electrode material layer, reducing oxygen release from the positive electrode active material, reducing the gas produced due to oxidative decomposition of the electrolyte at high temperature, and thereby improving the high-temperature storage performance and high-temperature cycling performance of the secondary battery. On the other hand, due to its continuous interface repair effect, the high percentage of the fluorinated solvent can not only improve the interface stability between the positive electrode material layer and the electrolyte, but also reduce the percentage of interface repair additives (such as vinylene carbonate, 1,3-propane sultone, or acrylonitrile) in the electrolyte, allowing for smaller initial impedance on the above interface, thereby further improving the high-temperature cycling performance and high-temperature cycling performance of the secondary battery. When the value of Ais excessively small, for example, less than 0.1, it cannot exert the effect of improving the stability of the positive electrode active material, which is not conducive to improving the high-temperature storage performance and high-temperature cycling performance of the secondary battery; and when the value of A is excessively large, for example, greater than 5, it leads to excessively large impedance of positive electrode plate and reduces a gram capacity of the positive electrode active material, which in turn reduces the energy density of the secondary battery and is not conducive to improving the high-temperature cycling performance thereof. When the value of B is excessively small, for example, less than 41.7, the role of the fluorinated solvent cannot be exerted, which is not conducive to alleviating the problem of dissolution of transition metals from the positive electrode material layer, and is not conducive to improving the high-temperature storage performance and high-temperature cycling performance of the secondary battery; and when the value of B is excessively large, for example, greater than 83.2, although the conductivity may be lower, the in-situ formed interface protective film is too thick, which hinders the transport of ions (such as lithium ions), thereby also not conducive to improving the high-temperature cycling performance of the secondary battery. When the value of 100A/B is excessively small, for example, less than 0.1, it is not conducive to exerting the synergistic effect between the positive electrode plate and the fluorinated solvent, and unable to improve the stability of the positive electrode active material and reduce the gas produced due to oxidative decomposition of the electrolyte at high temperature, thereby affecting the high-temperature storage performance and high-temperature cycling performance of the secondary battery. When the value of 100A/B is excessively large, for example, greater than 6, it leads to excessively large impedance of the positive electrode plate, hinders ion transport, and is also unable to exert the synergistic effect between the positive electrode plate and the fluorinated solvent, thereby unable to improve the high-temperature storage performance and high-temperature cycling performance of the secondary battery. Therefore, the positive electrode active material includes element cobalt and element magnesium, the electrolyte includes a fluorinated solvent, and the values of A, B, and 100A/B are regulated within the above ranges, so that a synergistic effect is generated between the positive electrode plate and the electrolyte, allowing the secondary battery to have high energy density while having good high-temperature storage performance and high-temperature cycling performance, and improving the overall performance of the secondary battery. In this application, “high temperature” refers to a temperature greater than or equal to 35 °C.

In an embodiment of this application, based on the mass of the positive electrode material layer, a mass percentage of element cobalt is C %, satisfying 51.1≤C≤58.8. For example, the value of C may be 51.1, 52, 53, 54, 55, 56, 57, 58, 58.8, or in a range defined by any two of the above values. Regulating the value of C within the above range allows the obtained positive electrode active material to have higher gram capacity, which helps increase the energy density of the secondary battery. In addition, this also allows for more stable structure of the positive electrode active material, reduces oxygen release from the positive electrode active material, reduces the gas produced due to oxidative decomposition of the electrolyte at high temperature, and helps exert the synergistic effect between the positive electrode plate and the electrolyte, thereby improving the high-temperature storage performance and high-temperature cycling performance of the secondary battery, allowing the secondary battery to have high energy density while having good high-temperature storage performance and high-temperature cycling performance, and improving the overall performance of the secondary battery.

In an embodiment of this application, the positive electrode active material includes Li_{α}Co_{1-x-y}MgₓM_{y}O_{β}, where 0.95≤α≤1.4, 0.004≤x≤0.192, 0≤y≤0.34, 1.9≤β≤2.1, and M includes at least one of Mn, Al, Ni, Ca, Ti, Zr, V, Cr, Fe, Cu, Zn, Rb, or Sn. For example, the value of a may be 0.95, 1, 1.1, 1.2, 1.3, 1.4, or in a range defined by any two of the above values, the value of x may be 0.004, 0.008, 0.01, 0.03, 0.05, 0.08, 0.1, 0.13, 0.15, 0.17, 0.192, or in a range defined by any two of the above values, the value of y may be 0, 0.005, 0.01, 0.015, 0.02, 0.025, 0.03, 0.34, or in a range defined by any two of the above values, and the value of 3 may be 1.9, 1.95, 1.98, 2, 2.02, 2.05, 2.1, or in a range defined by any two of the above values. The positive electrode active material may include but is not limited to at least one of LiCo_{0.92}Mg_{0.08}O₂, LiCo_{0.996}Mg_{0.004}O₂, LiCo_{0.98}Mg_{0.02}O₂, LiCo_{0.96}Mg_{0.04}O₂, LiCo_{0.88}Mg_{0.12}O₂, LiCo_{0.81}Mg_{0.19}O₂, LiCo_{0.87}Mg_{0.08}Mn_{0.05}O₂, LiCo_{0.87}Mg_{0.08}Al_{0.05}O₂, LiCo_{0.915}Mg_{0.08}Al_{0.005}O₂, or LiCo_{0.58}Mg_{0.08}Al_{0.34}O₂. Selection of the above positive electrode active material allows for more stable structure of the positive electrode material layer, reduces the gas produced due to oxidative decomposition of the electrolyte at high temperature, helps exert the synergistic effect between the positive electrode plate and the electrolyte, and allows the secondary battery provided in this application to have good high-temperature storage performance and high-temperature cycling performance.

In an embodiment of this application, the compound represented by formula (I) includes at least one of the following compounds:

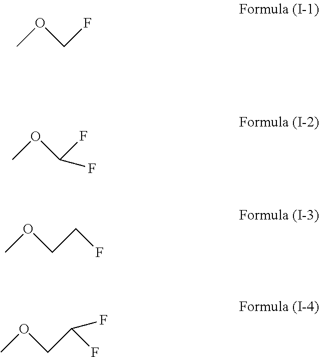

The compound represented by formula (II) includes at least one of the following compounds:

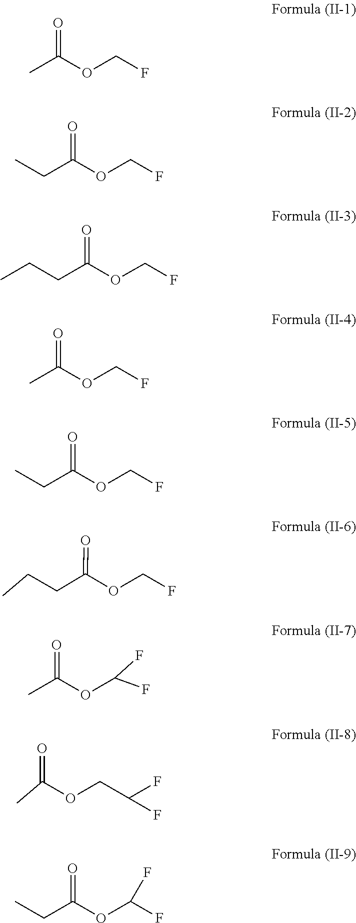

The compound represented by formula (III) includes at least one of the following compounds:

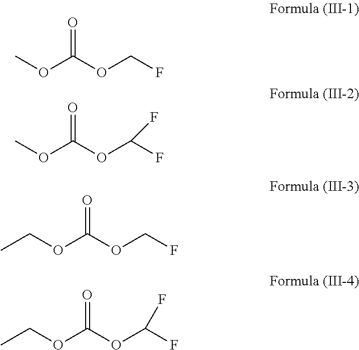

The compound represented by formula (IV) includes at least one of the following compounds:

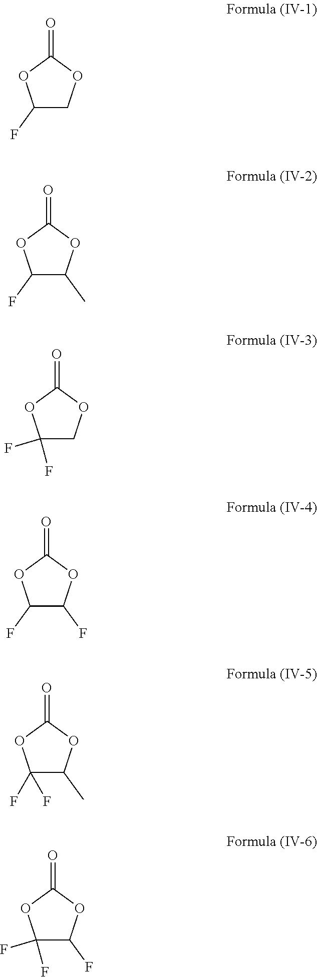

In an embodiment of this application, the electrolyte includes a compound represented by formula (V):

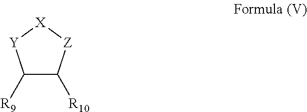

X is selected from any one of

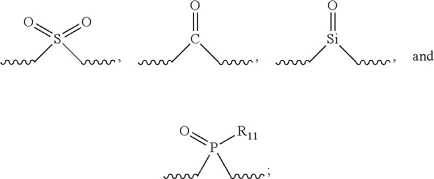

[symbol]

represents a binding site for binding to an adjacent atom. Y and Z are each independently selected from any one of C and O. R₉, R₁₀, and R₁₁ are each independently selected from H, substituted or unsubstituted C₁ to C₁₀ alkyl group, substituted or unsubstituted C₂ to C₁₀ alkenyl group, substituted or unsubstituted C₂ to C₁₀ alkynyl group, substituted or unsubstituted C₆ to C₁₀ aryl group, substituted or unsubstituted C₁ to C₁₀ alkoxy group, substituted or unsubstituted C₂ to C₁₀ cycloalkoxy group, substituted or unsubstituted C₂ to C₁₀ alkenyloxy group, substituted or unsubstituted C₂ to C₁₀ alkynyloxy group, substituted or unsubstituted C₆ to C₁₀ aryloxy group, substituted or unsubstituted C₁ to C₁₀ carboxyl group, substituted or unsubstituted C₁ to C₁₀ carbonyl group, substituted or unsubstituted C₁ to C₁₀ cyano group, substituted or unsubstituted C₁ to C₁₀ amino group, substituted or unsubstituted C₂ to C₁₀ carbonate group, substituted or unsubstituted C₁ to C₁₀ sulfate group, substituted or unsubstituted C₁ to C₁₀ sulfite group, substituted or unsubstituted C₁ to C₁₀ borate group, substituted or unsubstituted C₁ to C₁₀ silane group, substituted or unsubstituted C₁ to C₁₀ siloxane group, or substituted or unsubstituted C₁ to C₁₀ phosphate group. When substituted, the substituents of these groups are each independently selected from at least one of halogen atom or cyano group. Based on the mass of the electrolyte, a mass percentage of the compound represented by formula (V) is D %, satisfying 0.05≤D≤5. For example, the value of D may be 0.05, 0.1, 0.5, 1.5, 2, 2.5, 3, 3.5, 4, 4.5, 5, or in a range defined by any two of the above values. The electrolyte includes the compound represented by formula (V) and has the value of D regulated within the above range, so that the compound represented by formula (V) can priorly participate in the oxidation reaction on the surface of the positive electrode to generate a sulfur-containing compound with better oxidation resistance, improving the oxidation resistance of the positive electrode solid electrolyte interface film (CEI film). In addition, the above fluorinated solvent is prone to reduction reaction on the negative electrode plate, and the stability of the reduction product thereof needs to be further improved. The above compound represented by formula (V) can also participate in the reaction on the negative electrode surface prior to the fluorinated solvent, reducing the possibility of the fluorinated solvent participating in the reduction reaction on the surface of the negative electrode plate, further improving the interface stability between the negative electrode plate and the electrolyte, thereby further improving the high-temperature storage performance and high-temperature cycling performance of the secondary battery.

In an embodiment of this application, the compound represented by formula (V) includes at least one of the following compounds:

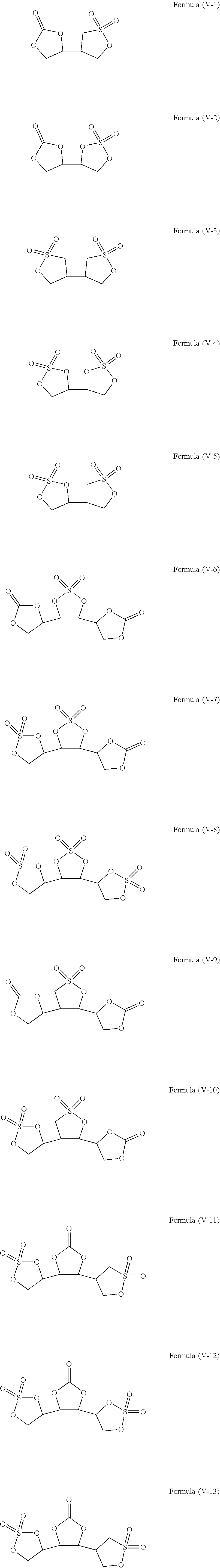

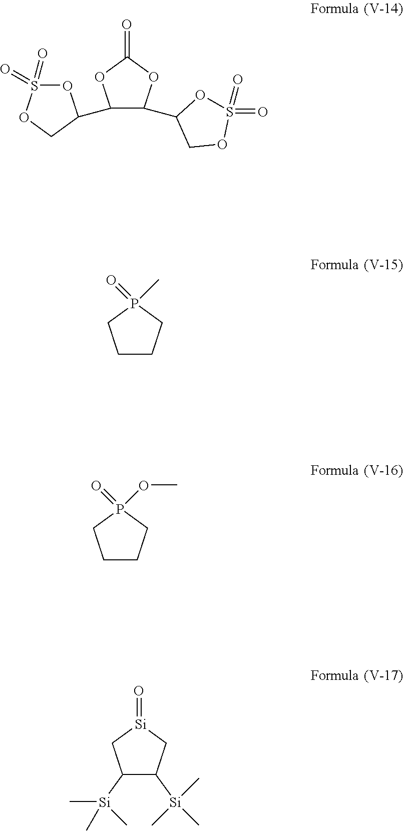

The compound represented by formula (V) including the above compounds is more conducive to exerting the role of the compound represented by formula (V), further improving the oxidation resistance of the CEI film and the interface stability between the negative electrode plate and the electrolyte, thereby allowing the secondary battery to have good high-temperature storage performance while having the high-temperature cycling performance further improved.

In an embodiment of this application, the electrolyte includes a nitrile compound, and based on the mass of the electrolyte, a percentage of the nitrile compound is E %, satisfying 0.1≤E≤8. For example, the value of E may be 0.1, 0.5, 1, 2, 3, 4, 5, 6, 7, 8, or in a range defined by any two of the above values. The nitrile compound includes malononitrile, succinonitrile, glutaronitrile, adiponitrile, octanedinitrile, terephthalonitrile, tetradecanedinitrile, azomalononitrile, methylene pentanedinitrile, pentenenitrile, 1,3,5-benzenetricarbonitrile, 2,4,6-trifluorobenzene-1,3,5-tricarbonitrile, 2-bromobenzene-1,3,5-tricarbonitrile, 1,3,6-hexanetricarbonitrile, 1,2,3-propanetricarbonitrile, 1,3,5-pentanetricarbonitrile, 1,2,6-hexanetricarbonitrile, or at least one of compounds represented by the following formulas (VI):

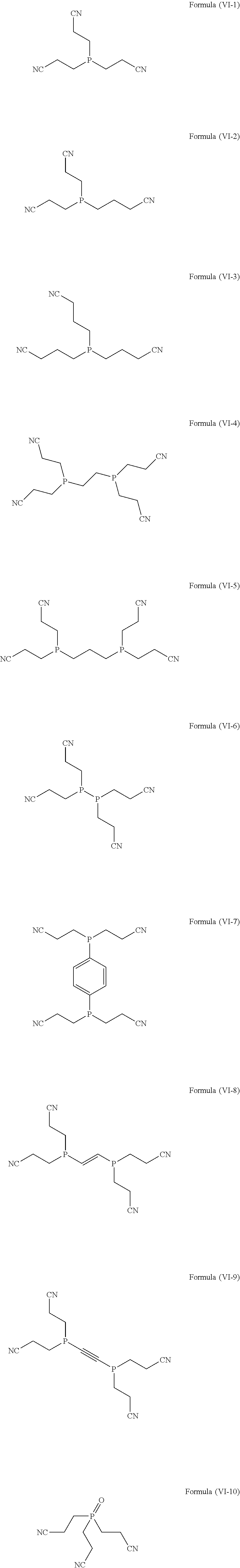

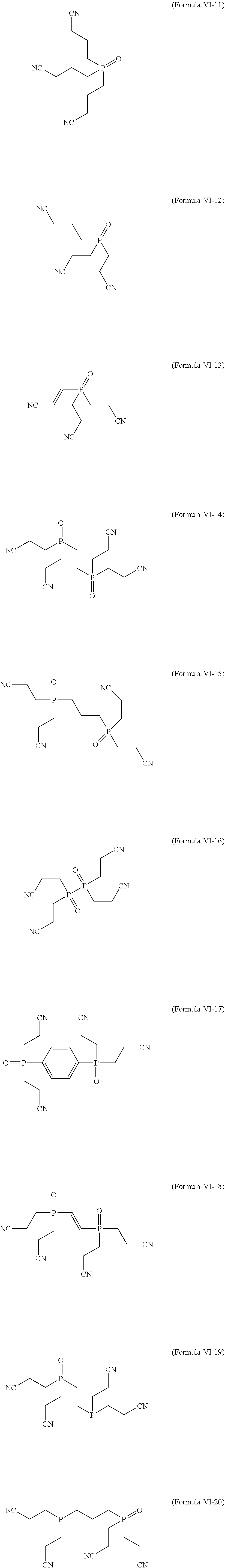

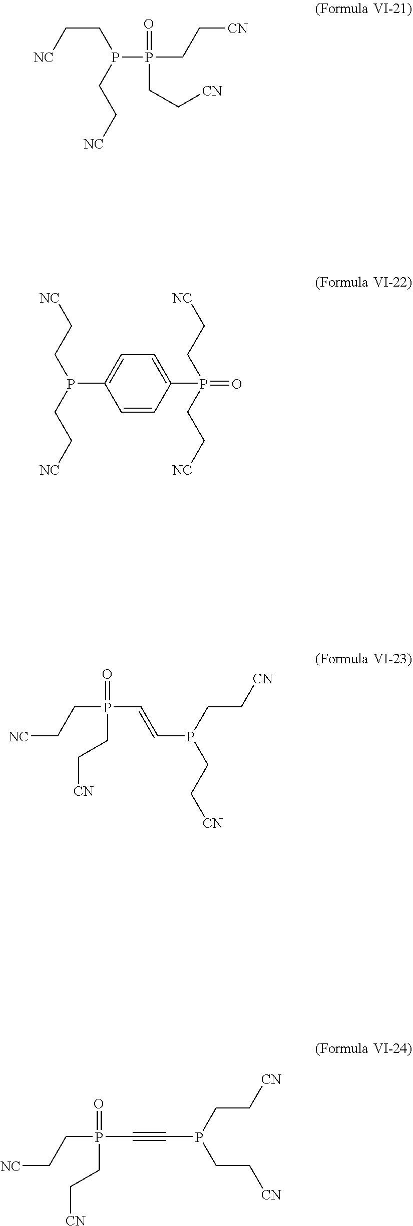

The electrolyte includes a nitrile compound and has the value of E regulated within the above range, so that the fluorine-containing solvent and the nitrile compound synergistically participate in the construction of the CEI film, allowing the composition of the CEI film to include both a fluorine-containing compound and a cyano-containing compound, improving the oxidation resistance of the CEI film while stabilizing the transition metals in the positive electrode active material, reducing side reactions in the electrolyte, reducing the gas produced due to oxidative decomposition of the electrolyte at high temperature, and due to the strong complexation of the nitrile compound with transition metals, further improving the high-temperature storage performance and high-temperature cycling performance of the secondary battery.

In an embodiment of this application, the electrolyte includes a carbonate compound and a carboxylate compound. Based on the mass of the electrolyte, the mass percentage of the carbonate compound is F %, a mass percentage of the carboxylate compound is G %, satisfying 8.2≤F≤24.9 and 8.2≤F+G≤41.5. For example, the value of F may be 8.2, 9, 10, 12, 14, 15, 16, 18, 20, 22, 24.9, or in a range defined by any two of the above values, and the value of F+G may be 8.2, 10, 15, 20, 23, 25, 28, 30, 33, 35, 38, 40, 41.5, or in a range defined by any two of the above values. The carbonate compound includes at least one of ethylene carbonate (EC), propylene carbonate (PC), butylene carbonate (BC), dimethyl carbonate (DMC), methyl ethyl carbonate (EMC), diethyl carbonate (DEC), dipropyl carbonate, methyl propyl carbonate (MPC), ethyl propyl carbonate, dioctyl carbonate, dipentyl carbonate, ethyl isobutyl carbonate, isopropyl methyl carbonate, di-n-butyl carbonate, diisopropyl carbonate, or propyl carbonate. The carboxylate compound includes at least one of methyl acetate (MA), ethyl acetate (EA), propyl acetate (PA), ethyl propionate (EP), propyl propionate (PP), butyl propionate, or pentyl propionate. The electrolyte includes a carbonate compound and a carboxylate compound, and has the values of F and F+G regulated within the above ranges, which is conducive to the dissociation of lithium salts and allows for appropriate viscosity of the electrolyte, conducive to exerting the interface repair effect of the fluorinated solvent, conducive to the transport of lithium ions, and can also reduce side reactions in the electrolyte, and reduce the gas produced due to oxidative decomposition of the electrolyte at high temperature, thereby improving the high-temperature storage performance, high-temperature cycling performance, and rate performance of the secondary battery.

In an embodiment of this application, 0≤G≤33.3. For example, the value of G may be 0, 3, 5, 8, 9, 10, 12, 14, 15, 16, 18, 20, 23, 25, 28, 30, 32, 33.3, or in a range defined by any two of the above values. Regulating the value of G within the above range allows for appropriate viscosity of the electrolyte, accelerates the transport of lithium ions, and can also reduce side reactions in the electrolyte, and reduce the gas produced due to oxidative decomposition of the electrolyte at high temperature, thereby improving the high-temperature storage performance, high-temperature cycling performance, and rate performance of the secondary battery.

In an embodiment of this application, the electrolyte includes a lithium salt. Based on the mass of the electrolyte, a mass percentage of the lithium salt is H %, satisfying 8≤H≤20. For example, the value of H may be 8, 9, 10, 12, 13, 15, 16, 18, 20, or in a range defined by any two of the above values. The lithium salt includes at least one of lithium hexafluorophosphate (LiPF₆), lithium bis(trifluoromethanesulfonyl)imide, lithium bis(fluorosulfonyl)imide, lithium tetrafluoroborate, lithium bis(oxalato)borate (LiBOB), lithium difluorooxalatoborate, or lithium difluorophosphate. The electrolyte includes a lithium salt, and has the value of H regulated within the above range, which is conducive to improving the ionic conductivity of the electrolyte, can shorten the charging time of the secondary battery, and can also reduce oxidation reactions in the electrolyte, thereby improving the high-temperature cycling performance of the secondary battery.

In some embodiments of this application, the electrolyte includes a lithium salt, a fluorinated solvent, and a carbonate compound. Optionally, the electrolyte includes at least one of a compound represented by formula (V) or a nitrile compound. The mass percentages of the lithium salt, fluorinated solvent, compound represented by formula (V), and nitrile compound are as described above. The mass percentage F % of the carbonate compound is 8.2% to 38.3%. For example, the value of F may be 8.2, 10, 12, 14, 15, 16, 18, 20, 24.9, 25.3, 28, 30, 30.3, 33.3, 35, 38.3, or in a range defined by any two of the above values. In some embodiments, the electrolyte includes a lithium salt, a fluorinated solvent, and a carbonate compound. The mass percentages of the lithium salt and fluorinated solvent are as described above. The mass percentage F % of the carbonate compound is 8.2% to 38.3%. In some embodiments, the electrolyte includes a lithium salt, a fluorinated solvent, a compound represented by formula (V), and a carbonate compound. The mass percentages of the lithium salt, fluorinated solvent, and compound represented by formula (V) are as described above. The mass percentage F % of the carbonate compound is 8.2% to 33.3%. In some embodiments, the electrolyte includes a lithium salt, a fluorinated solvent, a nitrile compound, and a carbonate compound; the mass percentages of the lithium salt, fluorinated solvent, and nitrile compound are as described above, and the mass percentage F % of the carbonate compound is 8.2% to 30.3%. In some embodiments, the electrolyte includes a lithium salt, a fluorinated solvent, a compound represented by formula (V), a nitrile compound, and a carbonate compound. The mass percentages of the lithium salt, fluorinated solvent, compound represented by formula (V), and nitrile compound are as described above. The mass percentage F % of the carbonate compound is 8.2% to 25.3%. Applying the above electrolyte to the secondary battery can improve the high-temperature storage performance, high-temperature cycling performance, and rate performance of the secondary battery.

In some other embodiments of this application, the electrolyte includes a lithium salt, a fluorinated solvent, a carbonate compound, and a carboxylate compound. Optionally, the electrolyte further includes at least one of a compound represented by formula (V) or a nitrile compound. The mass percentages of the lithium salt, fluorinated solvent, compound represented by formula (V), nitrile compound, carbonate compound, and carboxylate compound are as described above. Applying the above electrolyte to the secondary battery can improve the high-temperature storage performance, high-temperature cycling performance, and rate performance of the secondary battery.

This application does not particularly limit the preparation method of the positive electrode active material, provided that the objectives of this application can be achieved. For example, the preparation method of the positive electrode active material may include but is not limited to the following steps: LiCoO₂ (CAS No.: 12190-79-3) and a magnesium-containing compound are mixed to uniformity and then heat-treated in an air atmosphere to obtain the positive electrode active material. The magnesium-containing compound may include but is not limited to at least one of MgCO₃, MgO, or Mg(OH)₂. This application does not particularly limit the temperature, time, and heating rate in the above heat treatment, provided that the objectives of this application can be achieved. For example, the heat treatment temperature is 650 °C to 850 °C, the time is 22 h to 26 h, and the heating rate is 2 °C/min to 8 °C/min. This application does not particularly limit the mass ratio of LiCoO₂ to the magnesium-containing compound, provided that the objectives of this application can be achieved. Generally, the mass percentages of Co and Mg in the positive electrode active material can be regulated by changing the mass ratio of LiCoO₂ to the magnesium-containing compound. For example, increasing the mass ratio of LiCoO₂ to the magnesium-containing compound increases the mass percentage of Co and decreases the mass percentage of Mg; and decreasing the mass ratio of LiCoO₂ to the magnesium-containing compound decreases the mass percentage of Co and increases the mass percentage of Mg.

When the positive electrode active material includes element M, a compound containing element M can be added simultaneously when LiCoO₂ and the magnesium-containing compound are mixed during the preparation of the positive electrode active material. For example, when element M is Al, Ca, Ti, Zr, V, Cr, Fe, Mn, Cu, Zn, Rb, Sn, or Ni, the corresponding compound containing element M may be an oxide containing M, a hydroxide containing M, or a carbonate salt compound containing M. This application does not limit the oxide containing M, the hydroxide containing M, or the carbonate salt compound containing M, provided that the objectives of this application can be achieved. A percentage of element M in the positive electrode active material can be regulated by regulating the amount of the added compound containing M.

In this application, the positive electrode material layer may be disposed on one surface of a positive electrode current collector in a thickness direction thereof, or may be disposed on two surfaces of the positive electrode current collector in the thickness direction thereof. It should be noted that the “surface” herein may be an entire region of the positive electrode current collector or a partial region of the positive electrode current collector. This is not particularly limited in this application, provided that the objectives of this application can be achieved. This application does not particularly limit the positive electrode current collector, provided that the objectives of this application can be achieved. For example, the positive electrode current collector may include aluminum foil, aluminum alloy foil, or a composite current collector (such as an aluminum-carbon composite current collector).

The positive electrode material layer may further include a conductive agent and a binder. This application does not particularly limit the types of the conductive agent and binder, provided that the objectives of this application can be achieved. For example, the conductive agent may include but is not limited to at least one of conductive carbon black (Super P), carbon nanotubes (CNTs), carbon fibers, flake graphite, Ketjenblack, graphene, metal materials, or conductive polymers. The carbon nanotubes may include but are not limited to single-walled carbon nanotubes and/or multi-walled carbon nanotubes. The carbon fibers may include but are not limited to vapor grown carbon fibers (VGCF) and/or carbon nanofibers. The metal material may include but is not limited to metal powder and/or metal fiber, and specifically, the metal may include but is not limited to at least one of copper, nickel, aluminum, or silver. The conductive polymer may include but is not limited to at least one of a polyphenylene derivative, polyaniline, polythiophene, polyacetylene, or polypyrrole. For example, the binder may include but is not limited to at least one of at least one of polyacrylic acid, sodium polyacrylate, potassium polyacrylate, lithium polyacrylate, polyimide, polyvinyl alcohol, carboxymethyl cellulose, sodium carboxymethyl cellulose, lithium carboxymethyl cellulose, polyimide, polyamideimide, styrene-butadiene rubber, or polyvinylidene fluoride. This application does not particularly limit the mass ratio of the positive electrode active material, conductive agent, and binder in the positive electrode material layer. Persons skilled in the art can make a selection based on actual needs, provided that the objectives of this application can be achieved.

This application does not particularly limit thicknesses of the positive electrode current collector and positive electrode material layer, provided that the objectives of this application can be achieved. For example, the thickness of the positive electrode current collector is 6 μm to 15 μm, and the thickness of the positive electrode material layer is 30 μm to 125 μm. This application does not particularly limit the thickness of the positive electrode plate, provided that the objectives of this application can be achieved. For example, the thickness of the positive electrode plate is 50 μm to 260 μm.

In this application, the negative electrode plate includes a negative electrode current collector and a negative electrode material layer disposed on at least one surface of the negative electrode current collector. The “negative electrode material layer disposed on at least one surface of the negative electrode current collector” means that the negative electrode material layer may be disposed on one surface of the negative electrode current collector in a thickness direction thereof, or on two surfaces of the negative electrode current collector in the thickness direction thereof. It should be noted that the “surface” herein may be an entire region of the negative electrode current collector or a partial region of the negative electrode current collector. This is not particularly limited in this application, provided that the objectives of this application can be achieved.

This application does not particularly limit the negative electrode current collector, provided that the objectives of this application can be achieved. For example, the negative electrode current collector may include copper foil, copper alloy foil, nickel foil, stainless steel foil, titanium foil, foamed nickel, foamed copper, or a composite current collector (such as a lithium-copper composite current collector, a carbon-copper composite current collector, a nickel-copper composite current collector, or a titanium-copper composite current collector). The negative electrode current collector may be a metal plate without through holes or a porous metal plate with through holes.

The negative electrode material layer includes a negative electrode active material. This application does not particularly limit the negative electrode active material, provided that the objectives of this application can be achieved. For example, the negative electrode active material may include but is not limited to at least one of natural graphite, artificial graphite, mesocarbon microbeads, hard carbon, soft carbon, silicon, a silicon-carbon composite, Li—Sn alloy, Li—Sn—O alloy, Sn, SnO, SnO₂, spinel-structure lithiated TiO₂—Li₄Ti₅O₁₂, or Li—Al alloy. The negative electrode material layer may further include a conductive agent, a binder, and a thickener. This application does not particularly limit the types of the conductive agent, binder, and thickener, provided that the objectives of this application can be achieved. For example, the conductive agent and binder may be at least one of the foregoing conductive agents and binders, and the thickener may include but is not limited to at least one of sodium carboxymethyl cellulose or lithium carboxymethyl cellulose. This application does not particularly limit the mass ratio of the negative electrode active material, conductive agent, binder, and thickener in the negative electrode material layer. Persons skilled in the art can make a selection based on actual needs, provided that the objectives of this application can be achieved.

This application does not particularly limit the thickness of the negative electrode material layer, provided that the objectives of this application can be achieved. For example, the thickness of the negative electrode material layer is 30 μm to 180 μm. This application does not particularly limit the thickness of the negative electrode current collector, provided that the objectives of this application can be achieved. For example, the thickness of the negative electrode current collector is 6 μm to 12 μm. This application does not particularly limit the thickness of the negative electrode plate, provided that the objectives of this application can be achieved. For example, the thickness of the negative electrode plate is 50 μm to 370 μm.

In this application, the secondary battery further includes a separator used to separate the positive electrode plate and the negative electrode plate, prevent internal short circuits in the secondary battery, and allow electrolyte ions to pass freely without affecting the electrochemical charge and discharge process. This application does not particularly limit the separator, provided that the objectives of this application can be achieved. For example, the material of the separator may include but is not limited to at least one of polyolefins (PO) mainly composed of polyethylene (PE) and polypropylene (PP), polyester (for example, polyethylene terephthalate (PET) film), cellulose, polyimide (PI), polyamide (PA), spandex, or aramid. For example, polyethylene includes at least one of high-density polyethylene, low-density polyethylene, or ultrahigh-molecular-weight polyethylene. The type of the separator may include at least one of woven film, non-woven film, microporous film, composite film, laminated film, or spun film. In this application, the thickness of the separator is not particularly limited, provided that the objectives of this application can be achieved. For example, the thickness of the separator is 5 μm to 500 μm.

In some embodiments, the separator may include a substrate layer and a surface treatment layer. The substrate may be a non-woven fabric or composite film having a porous structure. The substrate may be made of at least one of polyethylene, polypropylene, polyethylene terephthalate, or polyimide. Optionally, a polypropylene porous film, a polyethylene porous film, polypropylene non-woven fabric, polyethylene non-woven fabric, or a polypropylene-polyethylene-polypropylene porous composite film may be used. Optionally, the surface treatment layer is provided on at least one surface of the substrate layer, and the surface treatment layer may be a polymer layer or an inorganic material layer, or a layer formed by a mixture of a polymer and an inorganic material. For example, the inorganic material layer includes inorganic particles and a binder. The inorganic particles are not particularly limited, and for example, may include at least one of aluminum oxide, silicon oxide, magnesium oxide, titanium oxide, hafnium dioxide, tin oxide, ceria oxide, nickel oxide, zinc oxide, calcium oxide, zirconium oxide, yttrium oxide, silicon carbide, boehmite, aluminum hydroxide, magnesium hydroxide, calcium hydroxide, or barium sulfate. The binder is not particularly limited, and for example, may be at least one of the foregoing binders. The polymer layer includes a polymer, and a material of the polymer includes at least one of polyamide, polyacrylonitrile, acrylate polymer, polyacrylic acid, polyacrylate salt, polyvinylpyrrolidone, polyvinyl ether, polyvinylidene fluoride, or poly(vinylidene fluoride-hexafluoropropylene).

A preparation process of the secondary battery is well known to persons skilled in the art, and is not particularly limited in this application. For example, the preparation process may include but is not limited to the following steps: a positive electrode plate, a separator, and a negative electrode plate are stacked in sequence and go through operations such as winding and folding as needed to obtain an electrode assembly with a winding structure, the electrode assembly is put into a packaging bag, and the packaging bag is injected with an electrolyte and sealed to obtain a secondary battery. Alternatively, a positive electrode plate, a separator, and a negative electrode plate are stacked in sequence, four corners of the entire laminated structure are fixed with tapes to obtain an electrode assembly with a laminated structure, the electrode assembly is put into a packaging bag, and the packaging bag is injected with an electrolyte and sealed to obtain a secondary battery. In addition, an over-current protection element, a guide, and the like may also be placed into the packaging bag as needed, so as to prevent pressure increase, overcharge, and discharge inside the secondary battery. The packaging bag is a packaging bag known in the field and is not limited in this application.

A second aspect of this application provides an electronic apparatus, including the secondary battery according to the first aspect of this application. The secondary battery according to the first aspect of this application has good high-temperature storage performance and high-temperature cycling performance, so the electronic apparatus according to the second aspect of this application has longer service life. This application does not particularly limit the type of the electronic apparatus, which may be any known electronic apparatus used in the prior art. In some embodiments of this application, the electronic apparatus may include but is not limited to a notebook computer, a pen-input computer, a mobile computer, an electronic book player, a portable telephone, a portable fax machine, a portable copier, a portable printer, a stereo headset, a video recorder, a liquid crystal display television, a portable cleaner, a portable CD player, a mini-disc player, a transceiver, an electronic notebook, a calculator, a storage card, a portable recorder, a radio, a backup power source, a motor, an automobile, a motorcycle, a power-assisted bicycle, a bicycle, a lighting appliance, a toy, a game console, a clock, an electric tool, a flash lamp, a camera, a large household battery, or a lithium-ion capacitor.

This application provides a secondary battery and an electronic apparatus. The secondary battery includes a positive electrode plate, a negative electrode plate, and an electrolyte. The positive electrode plate includes a positive electrode material layer, the positive electrode material layer includes a positive electrode active material, the positive electrode active material includes element cobalt and element magnesium, and based on a mass of the positive electrode material layer, a mass percentage of element magnesium is A %, satisfying 0.1≤A≤5. The electrolyte includes a fluorinated solvent, where the fluorinated solvent includes at least one of a compound represented by formula (I), a compound represented by formula (II), a compound represented by formula (III), or a compound represented by formula (IV). Based on a mass of the electrolyte, a mass percentage of the fluorinated solvent is B %, satisfying 41.7≤B≤83.2 and 0.1≤100A/B≤6. The positive electrode active material includes element cobalt and element magnesium, the electrolyte includes a fluorinated solvent, and the values of A, B, and 100A/B are regulated within the above ranges, so that a synergistic effect is generated between the positive electrode plate and the electrolyte, which is conducive to improving the stability of the positive electrode active material, reducing the gas produced due to oxidative decomposition of the electrolyte at high temperature, and thereby improving the high-temperature storage performance and high-temperature cycling performance of the secondary battery.

### DETAILED DESCRIPTION

To make the objectives, technical solutions, and advantages of this application clearer and more comprehensible, the following describes this application in detail with reference to embodiments. Apparently, the described embodiments are only some rather than all of the embodiments of this application. All other embodiments obtained by persons skilled in the art based on this application shall fall within the protection scope of this application.

It should be noted that in specific embodiments of this application, an example in which a lithium-ion battery is used as a secondary battery is used to illustrate this application. However, the secondary battery in this application is not limited to the lithium-ion battery.

### EXAMPLES

The following describes the embodiments of this application more specifically by using examples and comparative examples. Various tests and evaluations are performed in the following methods. In addition, unless otherwise specified, “part” and “%” are based on mass.

### Test Methods and Equipment:

### Test for Mass Percentages of Magnesium and Cobalt:

The lithium-ion battery was discharged to 3 V at 0.2C and then disassembled to obtain the positive electrode plate. The positive electrode material layer of the positive electrode plate after washed with DMC (dimethyl carbonate) was scraped off with a scraper to obtain the powder of the positive electrode material layer. 0.4 g of the powder was taken and dissolved in 12 mL of a mixed solvent. The mixed solvent was obtained by mixing aqua regia and hydrofluoric acid (HF) at a volume ratio of 5:1. Then, the obtained solution was diluted to 100 mL, and an inductively coupled plasma spectrometer (ICP) was used to test the contents of metal elements such as Co and Mg in the solution, so as to calculate the mass percentage A % of element magnesium and the mass percentage C % of element cobalt based on the mass of the positive electrode material layer. The aqua regia was obtained by mixing concentrated nitric acid and concentrated hydrochloric acid at a volume ratio of 1:1.

### Test for Component Percentages in Electrolyte:

The lithium-ion battery was discharged to 3 V at 0.2C and disassembled, the electrolyte was collected, and the detached positive electrode plate, negative electrode plate, and separator were centrifuged. The liquid obtained after centrifugation and the electrolyte were mixed to uniformity to obtain a liquid sample. The liquid sample was subjected to ion chromatography (IC) test to measure the percentage of the lithium salt in the electrolyte. The liquid sample was tested using the gas chromatography-mass spectrometry (GC-MS) method to measure the mass ratio of the components in the electrolyte, which was then combined with the measured percentage of the lithium salt to calculate the mass percentages of the components in the electrolyte.

### High-Temperature Storage Performance Test:

The thickness swelling rate after storage at 85 °C was used to evaluate the high-temperature storage performance of the lithium-ion battery. Lower thickness swelling rate indicated better high-temperature storage performance, and higher thickness swelling rate indicated worse high-temperature storage performance. At 25 °C, the lithium-ion battery was left standing for 5 minutes, charged to 3.85 V at a constant current of 0.7C to reach a half-charged state, and the thickness of the lithium-ion battery was measured and recorded as H₁. Then, the lithium-ion battery was charged to 4.5 V at a constant current of 0.7C, charged at constant voltage until the current reached 0.05C, and left standing for 10 minutes to reach a fully charged state. The fully charged lithium-ion battery was left standing in an 85 °C thermostat for 8 hours. After the lithium-ion battery was taken out, the thickness after storage was measured at 25 °C and recorded as H₂. The thickness swelling rate after high-temperature storage of the lithium-ion battery was calculated using the following formula: thickness swelling rate=(H₂/H₁−1)×100%.

### High-Temperature Cycling Performance Test:

The capacity retention rate at 45 °C was used to evaluate the high-temperature cycling performance of the lithium-ion battery. Higher capacity retention rate indicated better high-temperature cycling performance, and lower capacity retention rate indicated worse high-temperature cycling performance. At 45 °C, the lithium-ion battery was charged to 4.52 V at a constant current of 0.7C, then charged at a constant voltage of 4.5 V until the current was 0.05C, and then discharged to 3.0 V at a constant current of 1C. This was one charge-discharge cycle, at which time it was the first cycle. The discharge capacity in the first cycle of the lithium-ion battery was recorded as C₁. The lithium-ion battery was subjected to 500 charge-discharge cycles according to the above method, and the discharge capacity in the 500th cycle was recorded as C₅₀₀. The capacity retention rate at 45 °C=C₅₀₀/C₁×100%.

### Example 1-1

### <Preparation of Positive Electrode Active Material>

Magnesium carbonate (MgCO₃) and LiCoO₂ were mixed at a mass ratio of 6.7:90.1 and then mixed in a high-speed mixer at 300 r/min for 20 min to obtain a mixture. The mixture was placed in a kiln in air atmosphere, heated to 820 °C at 5 °C/min, maintained at that temperature for 24 h, taken out after natural cooling, and passed through a 300-mesh sieve to obtain a positive electrode active material.

### <Preparation of Positive Electrode Plate>

The prepared positive electrode active material, conductive agent carbon nanotubes (CNT), and a binder polyvinylidene fluoride were mixed at a mass ratio of 97.9:0.7:1.4, added with N-methylpyrrolidone (NMP) as a solvent, and stirred to uniformity by a vacuum mixer to obtain a positive electrode slurry with a solid content of 75 wt %. The positive electrode slurry was uniformly applied onto one surface of a positive electrode current collector aluminum foil with a thickness of 12 m, dried at 85 °C, and cold-pressed to obtain a positive electrode plate having a positive electrode material layer with a thickness of 100 m. Then, the foregoing steps were repeated on the other surface of the aluminum foil to obtain a positive electrode plate coated with positive electrode material layers on both surfaces. The positive electrode plate was cut as per a size of 74 mm×862 mm and then welded with tabs for later use.

### <Preparation of Negative Electrode Plate>

A negative electrode active material artificial graphite, styrene-butadiene rubber (SBR), and carboxymethyl cellulose (CMC) were mixed at a mass ratio of 95:2:3, added with deionized water as a solvent, and stirred to uniformity to obtain a slurry with a solid content of 70 wt %. The slurry was uniformly applied onto one surface of copper foil with a thickness of 8 μm, dried at 110 °C, and cold-pressed to obtain a negative electrode plate with one surface coated with a negative electrode material layer with a thickness of 150 m. Then, the foregoing steps were repeated on the other surface of the copper foil to obtain a negative electrode plate coated with negative electrode material layers on both surfaces. The negative electrode plate was cut as per a size of 75 mm×867 mm and then welded with tabs for later use.

### <Preparation of Electrolyte>

In an argon atmosphere glove box with a moisture content less than 10 ppm, a fluorinated solvent of formula (II-7) and a carbonate compound diethyl carbonate (DEC) were mixed, added with lithium hexafluorophosphate (LiPF₆), dissolved, and mixed to uniformity to obtain an electrolyte. Based on the mass of the electrolyte, the mass percentage H % of the lithium salt was 12.5%, and the mass percentage B % of the fluorinated solvent and the mass percentage F % of the carbonate compound were as shown in Table 1.

### <Separator>

A polyethylene microporous film (manufacturer: Celgard, LLC, USA) with a thickness of 15 m was used as a separator.

### <Preparation of Lithium-Ion Battery>

The prepared separator, positive electrode plate, separator, and negative electrode plate were stacked in sequence, so that the separator was between the positive electrode plate and the negative electrode plate for separation. Then, the resulting stack was wound into an electrode assembly. The electrode assembly was placed into an aluminum-plastic film packaging bag, dried in a vacuum oven at 85 °C for 12 h to remove moisture. The prepared electrolyte was injected, followed by vacuum packaging, standing, formation (charged to 4.3 V at a constant current of 0.05C and then discharged to 2.8 V at a constant current of 0.2C), shaping, capacity testing, secondary packaging, and other processes to obtain a lithium-ion battery.

### Examples 1-2 to 1-8

These examples were the same as Example 1-1 except that the related preparation parameters were adjusted according to Table 1. When the mass percentage of the fluorinated solvent changed, the mass percentage of the carbonate compound changed accordingly, and the mass percentage of the lithium salt remained unchanged.

### Examples 1-9 to 1-18

These examples were the same as Example 1-1 except that the carboxylate compound ethyl propionate (EP) was further introduced, the mass percentage B % of the fluorinated solvent, the mass percentage F % of the carbonate compound, and the mass percentage G % of the carboxylate compound were adjusted according to Table 1, and the mass percentage of the lithium salt remained unchanged.

### Examples 2-1 to 2-7

These examples were the same as Example 1-15 except that the related preparation parameters were adjusted according to Table 2. When the mass percentage F % of the carbonate compound and/or the mass percentage G % of the carboxylate compound changed, the mass percentage of the fluorinated solvent changed accordingly, and the mass percentage of the lithium salt remained unchanged.

### Example 2-8

This example was the same as Example 1-15 except that the electrolyte prepared in <Preparation of electrolyte> below was used.

### <Preparation of Electrolyte>

In an argon atmosphere glove box with a moisture content of less than 10 ppm, a fluorinated solvent of formula (II-8), a carbonate compound diethyl carbonate (DEC), and a carboxylate compound ethyl propionate (EP) were mixed, added with lithium hexafluorophosphate (LiPF₆), dissolved, and mixed to uniformity to obtain an electrolyte. Based on the mass of the electrolyte, the mass percentage B % of the fluorinated solvent was 58.5%, the mass percentage F % of the carbonate compound was 29%, with the mass percentage of EC being 10% and the mass percentage of DEC being 19%, and the mass percentage H % of the lithium salt was 12.5%.

### Example 2-9

This example was the same as Example 2-8 except that the type and mass percentage of the carbonate compound were adjusted according to Table 2. When the mass percentage of the carbonate compound changed, the mass percentage of the fluorinated solvent changed accordingly, and the mass percentage of the lithium salt remained unchanged.

### Example 3-1

This example was the same as Example 1-15 except that the manganese-containing compound manganese carbonate MnCO₃ was added to the mixture in <Preparation of positive electrode active material> to prepare the positive electrode active material with the composition as shown in Table 3.

### Example 3-2

This example was the same as Example 1-15 except that the aluminum-containing compound aluminum carbonate Al₂(CO₃)₃ was added to the mixture in <Preparation of positive electrode active material> to prepare the positive electrode active material with the composition as shown in Table 3.

### Examples 3-3 and 3-4

These examples were the same as Example 1-15 except that the addition amount of the aluminum-containing compound Al₂(CO₃)₃ was adjusted so that the composition of the positive electrode active material was as shown in Table 3.

### Examples 4-1 to 4-10

These examples were the same as Example 1-15 except that the compound represented by formula (V) was further introduced in <Preparation of electrolyte> and the type and mass percentage of the compound represented by formula (V) were adjusted according to Table 4. When the mass percentage of the compound represented by formula (V) changed, the sum of the mass percentages of the fluorinated solvent, carbonate compound, and carboxylate compound changed accordingly, and the mass ratio of the three and the mass percentage of the lithium salt remained unchanged.

### Examples 5-1 to 5-16

These examples were the same as Example 1-15 except that the nitrile compound was further introduced in <Preparation of electrolyte> and the type and mass percentage of the nitrile compound were adjusted according to Table 5. When the mass percentage of the nitrile compound changed, the sum of the mass percentages of the fluorinated solvent, carbonate compound, and carboxylate compound changed accordingly, and the mass ratio of the three and the mass percentage of the lithium salt remained unchanged.

### Examples 6-1 to 6-3

These examples were the same as Example 1-15 except that the type and mass percentage of the lithium salt were adjusted according to Table 6. When the mass percentage of the lithium salt changed, the sum of the mass percentages of the fluorinated solvent, carbonate compound, and carboxylate compound changed accordingly, and the mass ratio of the three remained unchanged.

### Example 7-1

This example was the same as Example 1-15 except that the compound represented by formula (V), formula (V-1), and the nitrile compound succinonitrile were further added according to Table 7 in the preparation of electrolyte, the sum of the mass percentages of the fluorinated solvent, carbonate compound, and carboxylate compound changed accordingly, and the mass ratio of the three and the mass percentage of the lithium salt remained unchanged.

### Comparative Example 1

This example was the same as Example 1-1 except that LiCoO₂ passed through a 300-mesh sieve was used as the positive electrode active material, no fluorinated solvent was added to the electrolyte, the mass percentage of the carbonate compound changed accordingly, and the mass percentage of the lithium salt remained unchanged.

### Comparative Examples 2 to 6

These examples were the same as Example 1-1 except that the related preparation parameters were adjusted according to Table 1. When the mass percentage of the fluorinated solvent changed, the mass percentage of the carbonate compound changed accordingly, and the mass percentage of the lithium salt remained unchanged.

Related parameters and performance tests of examples and comparative examples are shown in Tables 1 to 7.

TABLE 1

| | | | | | | | | | | | | Capac- |
|---|---|---|---|---|---|---|---|---|---|---|---|---|
| | | | | | | | | | | | Thick- | ity |
| | | | | | | | | | | | ness | reten- |
| | | | | | | | | | | | swelling | tion |
| | Mass ratio | | | | | | | | | | rate | rate |
| | of MgCO₃ | Positive electrode | | A | C | Fluorinated | B | | F | G | (%) at | (% )at |
| | to LiCoO₂ | active material | x | (%) | (%) | solvent | (%) | 100A/B | (%) | (%) | 85 °C | 45 °C |
| Example 1-1 | 6.7:90.1 | LiCo_{0.92}Mg_{0.08}O₂ | 0.08 | 2 | 55.8 | Formula (II-7) | 83.2 | 2.4 | 4.3 | / | 20.7 | 77.7 |
| Example 1-2 | 0.34:97.5 | LiCo_{0.996}Mg_{0.004}O₂ | 0.004 | 0.1 | 58.8 | Formula (II-7) | 83.2 | 0.12 | 4.3 | / | 26.4 | 70.9 |
| Example 1-3 | 1.7:95.9 | LiCo_{0.98}Mg_{0.02}O₂ | 0.02 | 0.5 | 58.1 | Formula (II-7) | 83.2 | 0.6 | 4.3 | / | 25.1 | 72.2 |
| Example 1-4 | 3.4:94.0 | LiCo_{0.96}Mg_{0.04}O₂ | 0.04 | 1 | 57.4 | Formula (II-7) | 83.2 | 1.2 | 4.3 | / | 23.1 | 74.5 |
| Example 1-5 | 10.1:86.2 | LiCo_{0.88}Mg_{0.12}O₂ | 0.12 | 3 | 54.1 | Formula (II-7) | 83.2 | 3.6 | 4.3 | / | 19.4 | 75.1 |
| Example 1-6 | 16:79.3 | LiCo_{0.81}Mg_{0.19}O₂ | 0.19 | 5 | 51.2 | Formula (II-7) | 83.2 | 6 | 4.3 | / | 25.8 | 71.6 |
| Example 1-7 | 6.7:90.1 | LiCo_{0.92}Mg_{0.08}O₂ | 0.08 | 2 | 55.8 | Formula (II-7) | 75 | 2.7 | 12.5 | / | 20.4 | 79.7 |
| Example 1-8 | 6.7:90.1 | LiCo_{0.92}Mg_{0.08}O₂ | 0.08 | 2 | 55.8 | Formula (II-7) | 66.7 | 3 | 20.8 | / | 19.5 | 81.1 |
| Example 1-9 | 6.7:90.1 | LiCo_{0.92}Mg_{0.08}O₂ | 0.08 | 2 | 55.8 | Formula (II-7) | 58.3 | 3.4 | 24.9 | 4.3 | 18.2 | 82.3 |
| Example 1-10 | 106.7:90.1 | LiCo_{0.92}Mg_{0.08}O₂ | 0.08 | 2 | 55.8 | Formula (II-7) | 54.2 | 3.7 | 24.9 | 8.4 | 17.9 | 83.6 |
| Example 1-11 | 6.7:90.1 | LiCo_{0.92}Mg_{0.08}O₂ | 0.08 | 2 | 55.8 | Formula (II-7) | 50 | 4 | 24.9 | 12.6 | 17.7 | 81.9 |
| Example 1-13 | 6.7:90.1 | LiCo_{0.92}Mg_{0.08}O₂ | 0.08 | 2 | 55.8 | Formula (II-7) | 41.7 | 4.8 | 24.9 | 20.9 | 17.8 | 72.8 |
| Example 1-14 | 6.7:90.1 | LiCo_{0.92}Mg_{0.08}O₂ | 0.08 | 2 | 55.8 | Formula (I-4) | 54.2 | 3.7 | 24.9 | 8.4 | 18.5 | 82.2 |
| Example 1-15 | 6.7:90.1 | LiCo_{0.92}Mg_{0.08}O₂ | 0.08 | 2 | 55.8 | Formula (II-8) | 54.2 | 3.7 | 24.9 | 8.4 | 18.1 | 83.5 |
| Example 1-16 | 6.7:90.1 | LiCo_{0.92}Mg_{0.08}O₂ | 0.08 | 2 | 55.8 | Formula (III-2) | 54.2 | 3.7 | 24.9 | 8.4 | 18.7 | 83.3 |
| Example 1-17 | 6.7:90.1 | LiCo_{0.92}Mg_{0.08}O₂ | 0.08 | 2 | 55.8 | Formula (III-4) | 54.2 | 3.7 | 24.9 | 8.4 | 18.2 | 82.7 |
| Example 1-18 | 6.7:90.1 | LiCo_{0.92}Mg_{0.08}O₂ | 0.08 | 2 | 55.8 | Formula (IV-4) | 54.2 | 3.7 | 24.9 | 8.4 | 18.3 | 82.2 |
| Comparative | / | LiCoO₂ | / | / | 58.9 | / | / | / | 87.5 | / | 30.5 | 60.2 |
| example 1 | | | | | | | | | | | | |
| Comparative | 0.17:97.7 | LiCo_{0.998}Mg_{0.002}O₂ | 0.002 | 0.05 | 58.8 | Formula (II-7) | 54.2 | 0.09 | 24.9 | 8.4 | 26.7 | 64.5 |
| example 2 | | | | | | | | | | | | |
| Comparative | 24.9:69.0 | LiCo_{0.71}Mg_{0.29}O₂ | 0.295 | 8 | 46.4 | Formula (II-7) | 54.2 | 14.7 | 24.9 | 8.4 | 27.7 | 54.7 |
| example 3 | | | | | | | | | | | | |
| Comparative | 6.7:90.1 | LiCo_{0.92}Mg_{0.08}O₂ | 0.08 | 2 | 55.8 | Formula (II-7) | 35 | 5.7 | 24.9 | 27.6 | 30.2 | 66.8 |
| example 4 | | | | | | | | | | | | |
| Comparative | 6.7:90.1 | LiCo_{0.92}Mg_{0.08}O₂ | 0.08 | 2 | 55.8 | Formula (II-7) | 87 | 2.3 | 0.5 | / | 29.3 | 70.4 |
| example 5 | | | | | | | | | | | | |
| Comparative | 15.9:79.5 | LiCo_{0.88}Mg_{0.12}O₂ | 0.12 | 3 | 52.3 | Formula (II-7) | 41.7 | 7.2 | 24.9 | 20.9 | 28.1 | 65.1 |
| example 6 | | | | | | | | | | | | |

Note:
″/″ in Table 1 indicates that a corresponding material or parameter does not exist.

From Examples 1-1 to 1-18 and Comparative examples 1 to 6, it can be seen that the positive electrode active material including element cobalt and element magnesium, the electrolyte including a fluorinated solvent, and the values of A, B, and 100A/B being regulated within the ranges of this application allow for lower thickness swelling rate at 85 °C and higher capacity retention rate at 45 °C, indicating that the lithium-ion battery has better high-temperature storage performance and high-temperature cycling performance. The positive electrode active material includes no element magnesium and the electrolyte includes no fluorinated solvent in Comparative example 1, and at least one of A, B, or 100A/B is not within the ranges of this application in Comparative examples 2 to 6, so the lithium-ion batteries have higher thickness swelling rate at 85 °C and lower capacity retention rate at 45 °C, indicating that the high-temperature storage performance and high-temperature cycling performance of the lithium-ion batteries are poor.

The value of A generally affects the high-temperature storage performance and high-temperature cycling performance of the lithium-ion battery. From Examples 1-1 to 1-6 and Comparative examples 2 to 3, it can be seen that when A is excessively small, for example, in Comparative example 2, the lithium-ion battery has higher thickness swelling rate at 85 °C and lower capacity retention rate at 45 °C; and when A is excessively large, for example, in Comparative example 3, the lithium-ion battery has higher thickness swelling rate at 85 °C and lower capacity retention rate at 45 °C. This indicates that when the value of A is not within the range of this application, the high-temperature storage performance and high-temperature cycling performance of the lithium-ion battery cannot be improved. Therefore, regulating the value of A within the range of this application allows the lithium-ion battery to have lower thickness swelling rate at 85 °C and higher capacity retention rate at 45 °C, indicating that the lithium-ion battery has good high-temperature storage performance and high-temperature cycling performance.

The value of B generally affects the high-temperature storage performance and high-temperature cycling performance of the lithium-ion battery. From Example 1-1, examples 1-7 to 1-13, and Comparative examples 4 to 5, it can be seen that when B is excessively small, for example, in Comparative example 4, the lithium-ion battery has higher thickness swelling rate at 85 °C and lower capacity retention rate at 45 °C; and when B is excessively large, for example, in Comparative example 5, the lithium-ion battery has higher thickness swelling rate at 85 °C and lower capacity retention rate at 45 °C. This indicates that when the value of B is not within the range of this application, the high-temperature storage performance and high-temperature cycling performance of the lithium-ion battery cannot be improved. Therefore, regulating the value of B within the range of this application allows the lithium-ion battery to have lower thickness swelling rate at 85 °C and higher capacity retention rate at 45 °C, indicating that the lithium-ion battery has good high-temperature storage performance and high-temperature cycling performance.

The value of 100A/B generally affects the high-temperature storage performance and high-temperature cycling performance of the lithium-ion battery. From Examples 1-1 to 1-13 and Comparative example 6, it can be seen that regulating the value of 100A/B within the range of this application allows the lithium-ion battery to have lower thickness swelling rate at 85 °C and higher capacity retention rate at 45 °C, indicating that the lithium-ion battery has better high-temperature storage performance and high-temperature cycling performance.

The value of C generally affects the high-temperature storage performance and high-temperature cycling performance of the lithium-ion battery. From Examples 1-1 to 1-6, it can be seen that regulating the value of C within the range of this application allows the lithium-ion battery to have lower thickness swelling rate at 85 °C and higher capacity retention rate at 45 °C, indicating that the lithium-ion battery has good high-temperature storage performance and high-temperature cycling performance.

The type of the fluorinated solvent generally affects the high-temperature storage performance and high-temperature cycling performance of the lithium-ion battery. From Example 1-1 and Examples 1-14 to 1-18, it can be seen that selecting the fluorinated solvent within the range of this application allows the lithium-ion battery to have lower thickness swelling rate at 85 °C and higher capacity retention rate at 45 °C, indicating that the lithium-ion battery has good high-temperature storage performance and high-temperature cycling performance.

TABLE 2

| | | | | | | Thickness | Capacity |
|---|---|---|---|---|---|---|---|
| | | | | | | swelling | retention |
| | Carbonate | F | Carboxylate | G | F + G | rate (%) at | rate (%) |
| | compound | (%) | compound | (%) | (%) | 85 °C | at 45 °C |
| Example 1-1 | DEC | 4.3 | / | / | 4.3 | 20.7 | 77.7 |
| Example 1-15 | DEC | 24.9 | EP | 8.4 | 33.3 | 18.1 | 83.5 |
| Example 2-1 | EC | 10 | EP | 19 | 29 | 19.1 | 84.5 |
| Example 2-2 | EC | 10 | PP | 19 | 29 | 18.7 | 85.2 |
| Example 2-3 | PC | 10 | EP | 19 | 29 | 18.2 | 86.8 |
| Example 2-4 | PC | 10 | PP | 19 | 29 | 17.6 | 87.3 |
| Example 2-5 | EC | 15 | PP | 10 | 25 | 19.9 | 86.1 |
| Example 2-6 | EC | 24.9 | PP | 16.6 | 41.5 | 20.2 | 78.6 |
| Example 2-7 | EC | 8.2 | PP | 33.3 | 41.5 | 16.2 | 78.3 |
| Example 2-8 | EC + DEC | 10 + 19 | / | / | 29 | 20.5 | 77.9 |
| Example 2-9 | EC | 8.2 | / | / | 8.2 | 20.1 | 78.1 |

Note:
″/″ in Table 2 indicates that a corresponding material or parameter does not exist.

The types of the carbonate compound and carboxylate compound generally affect the high-temperature storage performance and high-temperature cycling performance of the lithium-ion battery. From Example 1-1 and Examples 2-1 to 2-4, it can be seen that selecting the carbonate compound and carboxylate compound within the ranges of this application allows the lithium-ion battery to have lower thickness swelling rate at 85 °C and higher capacity retention rate at 45 °C, indicating that the lithium-ion battery has good high-temperature storage performance and high-temperature cycling performance.

The mass percentage F % of the carbonate compound, the mass percentage G % of the carboxylate compound, and the value of F+G generally affect the high-temperature storage performance and high-temperature cycling performance of the lithium-ion battery. From Example 1-1, Example 1-15, Example 2-1, and Examples 2-5 to 2-9, it can be seen that regulating the values of F, G, and F+G within the ranges of this application allows the lithium-ion battery to have lower thickness swelling rate at 85 °C and higher capacity retention rate at 45 °C, indicating that the lithium-ion battery has good high-temperature storage performance and high-temperature cycling performance.

TABLE 3

| | | | | | | Thickness | Capacity |
|---|---|---|---|---|---|---|---|
| | | | | | | swelling | retention |
| | Positive electrode | Element | | A | C | rate (%) | rate (%) |
| | active material | M | y | (%) | (%) | at 85 °C | at 45 °C |
| Example 1-15 | LiCo_{0.92}Mg_{0.08}O₂ | / | / | 2 | 57 | 18.1 | 83.5 |
| Example 3-1 | LiCo_{0.87}Mg_{0.08}Mn_{0.05}O₂ | Mn | 0.05 | 2.1 | 52.3 | 14.5 | 84.7 |
| Example 3-2 | LiCo_{0.87}Mg_{0.08}Al_{0.05}O₂ | Al | 0.05 | 2.1 | 52.2 | 13.2 | 85.1 |
| Example 3-3 | LiCo_{0.915}Mg_{0.08}Al_{0.005}O₂ | Al | 0.005 | 2 | 55.6 | 17.8 | 83.6 |
| Example 3-4 | LiCo_{0.58}Mg_{0.08}Al_{0.34}O₂ | Al | 0.34 | 2.3 | 39.7 | 17.4 | 83.8 |

Note:
″/″ in Table 3 indicates that a corresponding material or parameter does not exist.

The types of the positive electrode active material and element M generally affect the high-temperature storage performance and high-temperature cycling performance of the lithium-ion battery. From Examples 1-15, 3-1, and 3-2, it can be seen that the positive electrode active material including element M within the range of this application allows the lithium-ion battery to have lower thickness swelling rate at 85 °C and higher capacity retention rate at 45 °C, indicating that the lithium-ion battery has good high-temperature storage performance and high-temperature cycling performance.

The value of y generally affects the high-temperature storage performance and high-temperature cycling performance of the lithium-ion battery. From Examples 1-15, 3-1, 3-3, and 3-4, it can be seen that regulating the value of y within the range of this application allows the lithium-ion battery to have lower thickness swelling rate at 85 °C and higher capacity retention rate at 45 °C, indicating that the lithium-ion battery has good high-temperature storage performance and high-temperature cycling performance.

TABLE 4

| | | | Thickness | Capacity |
|---|---|---|---|---|
| | Compound | | swelling | retention |
| | represented by | D | rate (%) | rate (%) |
| | formula (V) | (%) | at 85 °C | at 45 °C |
| Example 1-15 | / | / | 18.1 | 83.5 |
| Example 4-1 | Formula (V-1) | 0.05 | 17.9 | 83.8 |
| Example 4-2 | Formula (V-1) | 1 | 17.1 | 84.4 |
| Example 4-3 | Formula (V-1) | 2 | 16.2 | 86.4 |
| Example 4-4 | Formula (V-1) | 3 | 15.1 | 87.5 |
| Example 4-5 | Formula (V-1) | 5 | 14.8 | 84.1 |
| Example 4-6 | Formula (V-4) | 3 | 14.7 | 85.6 |
| Example 4-7 | Formula (V-5) | 3 | 16.2 | 87.8 |
| Example 4-8 | Formula (V-12) | 3 | 15.8 | 86.3 |
| Example 4-9 | Formula (V-16) | 3 | 14.5 | 84.6 |
| Example 4-10 | Formula (V-17) | 3 | 16.1 | 84.3 |

Note:
“/” in Table 4 indicates that a corresponding material or parameter does not exist.

The mass percentage D % of the compound represented by formula (V) generally affects the high-temperature storage performance and high-temperature cycling performance of the lithium-ion battery. From Example 1-15 and Examples 4-1 to 4-5, it can be seen that regulating the value of D within the range of this application allows the lithium-ion battery to have lower thickness swelling rate at 856C and higher capacity retention rate at 45C, indicating that the lithium-ion battery has good high-temperature storage performance and high-temperature cycling performance.

The type of the compound represented by formula (V) generally affects the high-temperature storage performance and high-temperature cycling performance of the lithium-ion battery. From Examples 4-6 to 4-10, it can be seen that selecting the compound represented by formula (V) within the range of this application allows the lithium-ion battery to have lower thickness swelling rate at 85 °C and higher capacity retention rate at 45C, indicating that the lithium-ion battery has good high-temperature storage performance and high-temperature cycling performance.

TABLE 5

| | | | Thickness | Capacity |
|---|---|---|---|---|
| | | | swelling | retention |
| | | E | rate (%) | rate (%) |
| | Nitrile compound | (%) | at 85 °C | at 45 °C |
| Example 1-15 | / | / | 18.1 | 83.5 |
| Example 5-1 | Succinonitrile | 2 | 17.8 | 83.7 |
| Example 5-2 | Succinonitrile | 0.1 | 14.5 | 86.6 |
| Example 5-3 | Succinonitrile | 8 | 13.1 | 83.8 |
| Example 5-4 | Succinonitrile + 1,3,6- | 0.2 | 17.3 | 84.1 |
| | hexanetricarbonitrile | | | |
| Example 5-5 | Succinonitrile + 1,3,6- | 1 | 16.1 | 84.9 |
| | hexanetricarbonitrile | | | |
| Example 5-6 | Succinonitrile + 1,3,6- | 4 | 12.1 | 88.3 |
| | hexanetricarbonitrile | | | |
| Example 5-7 | Succinonitrile + 1,3,6- | 6 | 10.3 | 90.6 |
| | hexanetricarbonitrile | | | |
| Example 5-8 | Succinonitrile + 1,3,6- | 8 | 9.7 | 85.2 |
| | hexanetricarbonitrile | | | |
| Example 5-9 | Succinonitrile + 1,3,6- | 12 | 23.1 | 75.9 |
| | hexanetricarbonitrile | | | |
| Example 5-10 | Adiponitrile | 2 | 13.7 | 85.3 |
| Example 5-11 | Octanedinitrile | 2 | 15.1 | 84.9 |
| Example 5-12 | Formula (VI-1) | 2 | 12.6 | 84.3 |
| Example 5-13 | Formula (VI-8) | 2 | 13.1 | 87.4 |
| Example 5-14 | Formula (VI-9) | 2 | 13.5 | 86.1 |
| Example 5-15 | Formula (VI-12) | 2 | 15.1 | 84.8 |
| Example 5-16 | Formula (VI-17) | 2 | 16.3 | 84.2 |

Note:
“/” in Table 5 indicates that a corresponding material does not exist.
In Examples 5-4 to 5-9, the mass ratio of succinonitrile to 1,3,6-hexanetricarbonitrile is 1:1.

The mass percentage E % of the nitrile compound generally affects the high-temperature storage performance and high-temperature cycling performance of the lithium-ion battery. From Example 1-15 and Examples 5-1 to 5-9, it can be seen that regulating the value of E within the range of this application allows the lithium-ion battery to have lower thickness swelling rate at 85 °C and higher capacity retention rate at 45 °C, indicating that the lithium-ion battery has good high-temperature storage performance and high-temperature cycling performance.

The type of the nitrile compound generally affects the high-temperature storage performance and high-temperature cycling performance of the lithium-ion battery. From Example 5-1 and Examples 5-10 to 5-16, it can be seen that selecting the nitrile compound within the range of this application allows the lithium-ion battery to have lower thickness swelling rate at 85 °C and higher capacity retention rate at 45 °C, indicating that the lithium-ion battery has good high-temperature storage performance and high-temperature cycling performance.

TABLE 6

| | | | Thickness | Capacity |
|---|---|---|---|---|
| | | | swelling | retention |
| | | H | rate (%) | rate (%) |
| | Lithium salt | (%) | at 85 °C | at 45 °C |
| Example 1-15 | LiPF₆ | 12.5 | 18.1 | 83.5 |
| Example 6-1 | LiPF₆ | 8 | 18.3 | 83.1 |
| Example 6-2 | LiPF₆ | 20 | 16.7 | 84.6 |
| Example 6-3 | LiBOB + LiTFSI | 0.5 + 12 | 18.5 | 85.4 |

Note:
“0.5 + 12” in Table 6 indicates that the mass percentage of LiBOB is 0.5%, and the mass percentage of LiTFSI is 12%.

The mass percentage H % of the lithium salt generally affects the high-temperature storage performance and high-temperature cycling performance of the lithium-ion battery. From Examples 1-15, 6-1, and 6-2, it can be seen that regulating the value of H within the range of this application allows the lithium-ion battery to have lower thickness swelling rate at 85 °C and higher capacity retention rate at 45 °C, indicating that the lithium-ion battery has good high-temperature storage performance and high-temperature cycling performance.

The type of the lithium salt generally affects the high-temperature storage performance and high-temperature cycling performance of the lithium-ion battery. From Examples 6-1 and 6-3, it can be seen that selecting the lithium salt within the range of this application allows the lithium-ion battery to have lower thickness swelling rate at 85 °C and higher capacity retention rate at 45 °C, indicating that the lithium-ion battery has good high-temperature storage performance and high-temperature cycling performance.

TABLE 7

| | | | | | | | Thickness | Capacity |
|---|---|---|---|---|---|---|---|---|
| | | | | | | | swelling | retention |
| | B | D | E | F | G | F + G | rate (%) | rate (%) |
| | (%) | (%) | (%) | (%) | (%) | (%) | at 85 °C | at 45 °C |
| Example 1-15 | 54.2 | / | / | 24.9 | 8.4 | 33.3 | 18.1 | 83.5 |
| Example 4-4 | 52.3 | 3 | / | 9.7 | 22.5 | 32.2 | 15.1 | 87.5 |
| Example 5-1 | 53.0 | / | 2 | 9.8 | 22.7 | 32.5 | 17.8 | 83.7 |
| Example 7-1 | 51.1 | 3 | 2 | 9.4 | 22.0 | 31.4 | 12.3 | 88.1 |

Note:
″/″ in Table 7 indicates that a corresponding material was not added.

From Examples 1-15, 4-4, 5-1, and 7-1, it can be seen that the electrolyte simultaneously includes a fluorinated solvent, carbonate compound, carboxylate compound, compound represented by formula (V), and nitrile compound, and the values of B, D, E, F, G, and F+G are regulated within the ranges of this application, which allows the lithium-ion battery to have lower thickness swelling rate at 85 °C and higher capacity retention rate at 45 °C, indicating that the lithium-ion battery has better high-temperature storage performance and high-temperature cycling performance.

The foregoing descriptions are merely preferred embodiments of this application, but are not intended to limit this application. Any modification, equivalent replacement, or improvement made without departing from the principle of this application shall fall within the protection scope of this application.

What is claimed is:

1. A secondary battery comprising a positive electrode plate, a negative electrode plate, and an electrolyte; wherein the positive electrode plate comprises a positive electrode material layer, the positive electrode material layer comprises a positive electrode active material, the positive electrode active material comprises element cobalt and element magnesium; and based on a mass of the positive electrode material layer, a mass percentage of the element magnesium is A %, satisfying 0.1≤A≤5;
the electrolyte comprises a fluorinated solvent, the fluorinated solvent comprising at least one of a compound represented by formula (I), a compound represented by formula (II), a compound represented by formula (III), or a compound represented by formula (IV): 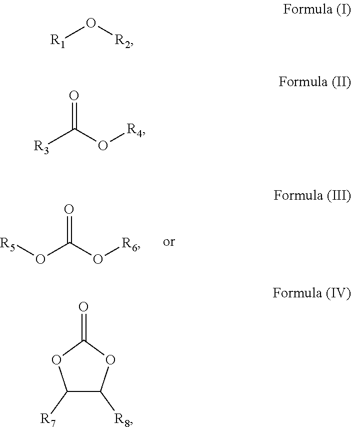
wherein R₁ and R₂ are each independently selected from C₁ to C₅ alkyl group substituted or unsubstituted by fluorine, C₂ to C₅ alkenyl group substituted or unsubstituted by fluorine, C₂ to C₅ alkynyl group substituted or unsubstituted by fluorine, C₂ to C₅ alkyl group substituted by sulfonic acid group, or C₂ to C₅ alkyl group substituted by cyano group; R₃ to R₈ are each independently selected from H, F, C₁ to C₅ alkyl group substituted or unsubstituted by fluorine, C₂ to C₅ alkenyl group substituted or unsubstituted by fluorine, C₂ to C₅ alkynyl group substituted or unsubstituted by fluorine, C₂ to C₅ alkyl group substituted by sulfonic acid group, or C₂ to C₅ alkyl group substituted by cyano group; and at least one of R₁ and R₂ contains at least one fluorine atom, at least one of R₃ and R₄ contains at least one fluorine atom, at least one of R₅ and R₆ contains at least one fluorine atom, and at least one of R₇ and R₈ contains at least one fluorine atom; and
based on a mass of the electrolyte, a mass percentage of the fluorinated solvent is B %, satisfying 41.7≤B≤83.2 and 0.1≤100A/B≤6.

2. The secondary battery according to claim 1, wherein 0.5≤A≤3 and 45.9≤B≤75.

3. The secondary battery according to claim 1, wherein based on the mass of the positive electrode material layer, a mass percentage of the element cobalt is C %, satisfying 51.1≤C≤58.8.

4. The secondary battery according to claim 1, wherein the positive electrode active material comprises Li_{α}Co_{1-x-y}MgₓM_{y}O_{β}, wherein 0.95≤α≤1.4, 0.004≤x≤0.192, 0≤y≤0.34, 1.9≤β≤2.1, and M comprises at least one of Mn, Al, Ni, Ca, Ti, Zr, V, Cr, Fe, Cu, Zn, Rb, or Sn.

5. The secondary battery according to claim 1, wherein the compound represented by formula (I) comprises at least one of the following compounds: 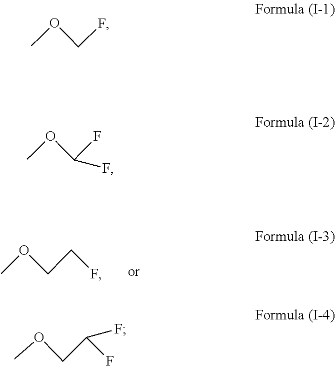
the compound represented by formula (II) comprises at least one of the following compounds: 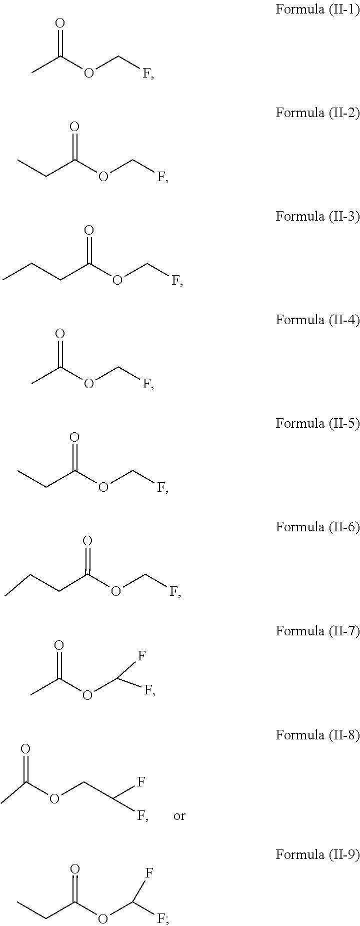
the compound represented by formula (III) comprises at least one of the following compounds: 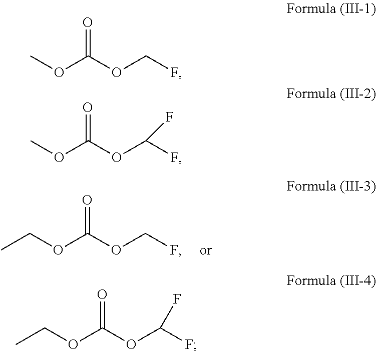
and
the compound represented by formula (IV) comprises at least one of the following compounds:

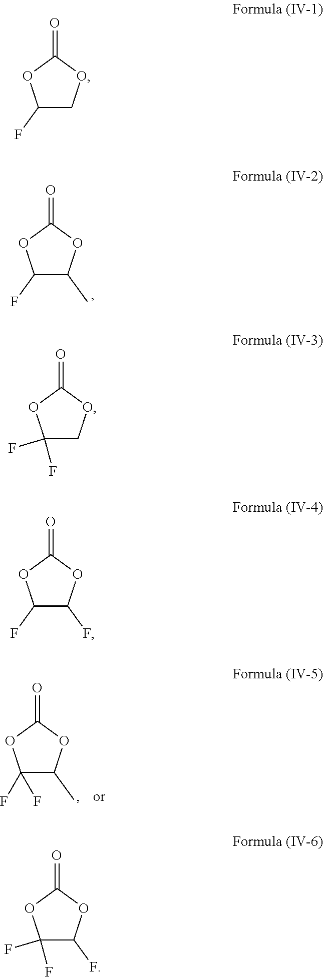

6. The secondary battery according to claim 1, wherein the electrolyte comprises a compound represented by formula (V): 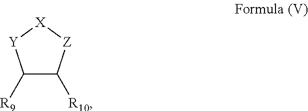
wherein X is selected from any one of 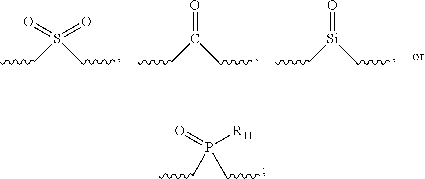 [symbol]
represents a binding site for binding to an adjacent atom; and Y and Z are each independently selected from any one of C or O;
R₉, R₁₀, and R₁₁ are each independently selected from H, substituted or unsubstituted C₁ to C₁₀ alkyl group, substituted or unsubstituted C₂ to C₁₀ alkenyl group, substituted or unsubstituted C₂ to C₁₀ alkynyl group, substituted or unsubstituted C₆ to C₁₀ aryl group, substituted or unsubstituted C₁ to C₁₀ alkoxy group, substituted or unsubstituted C₂ to C₁₀ cycloalkoxy group, substituted or unsubstituted C₂ to C₁₀ alkenyloxy group, substituted or unsubstituted C₂ to C₁₀ alkynyloxy group, substituted or unsubstituted C₆ to C₁₀ aryloxy group, substituted or unsubstituted C₁ to C₁₀ carboxyl group, substituted or unsubstituted C₁ to C₁₀ carbonyl group, substituted or unsubstituted C₁ to C₁₀ cyano group, substituted or unsubstituted C₁ to C₁₀ amino group, substituted or unsubstituted C₂ to C₁₀ carbonate group, substituted or unsubstituted C₁ to C₁₀ sulfate group, substituted or unsubstituted C₁ to C₁₀ sulfite group, substituted or unsubstituted C₁ to C₁₀ borate group, substituted or unsubstituted C₁ to C₁₀ silane group, substituted or unsubstituted C₁ to C₁₀ siloxane group, or substituted or unsubstituted C₁ to C₁₀ phosphate group; and when substituted, the substituents of these groups are each independently selected from at least one of halogen atom or cyano group; and
based on the mass of the electrolyte, a mass percentage of the compound represented by formula (V) is D %, satisfying 0.05≤D≤5.

7. The secondary battery according to claim 6, wherein the compound represented by formula (V) comprises at least one of the following compounds:

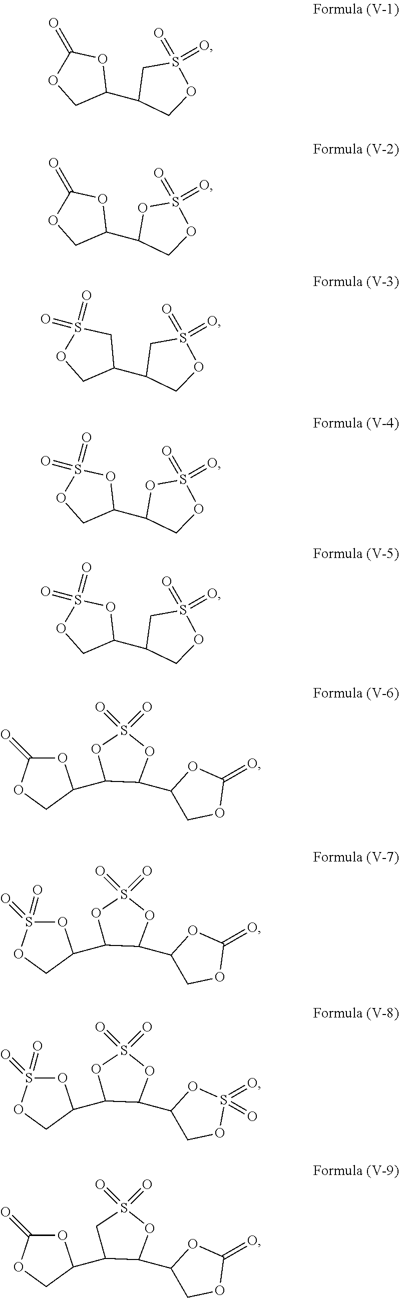

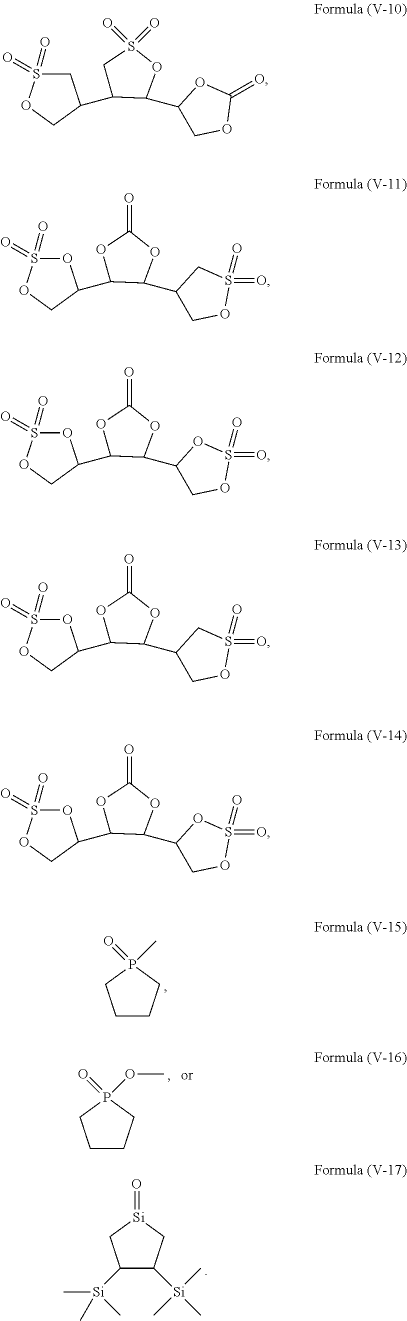

8. The secondary battery according to claim 1, wherein the electrolyte comprises a nitrile compound; and based on the mass of the electrolyte, a percentage of the nitrile compound is E %, satisfying 0.1≤E≤8; wherein
the nitrile compound comprises malononitrile, succinonitrile, glutaronitrile, adiponitrile, octanedinitrile, terephthalonitrile, tetradecanedinitrile, azomalononitrile, methylene pentanedinitrile, pentenenitrile, 1,3,5-benzenetricarbonitrile, 2,4,6-trifluorobenzene-1,3,5-tricarbonitrile, 2-bromobenzene-1,3,5-tricarbonitrile, 1,3,6-hexanetricarbonitrile, 1,2,3-propanetricarbonitrile, 1,3,5-pentanetricarbonitrile, 1,2,6-hexanetricarbonitrile, or at least one of compounds represented by the following formulas (VI):

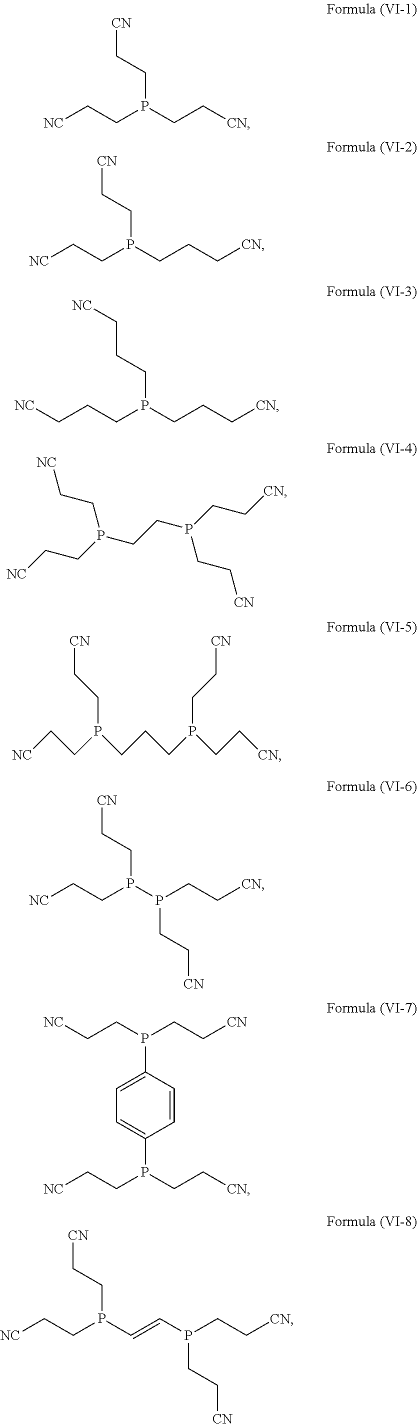

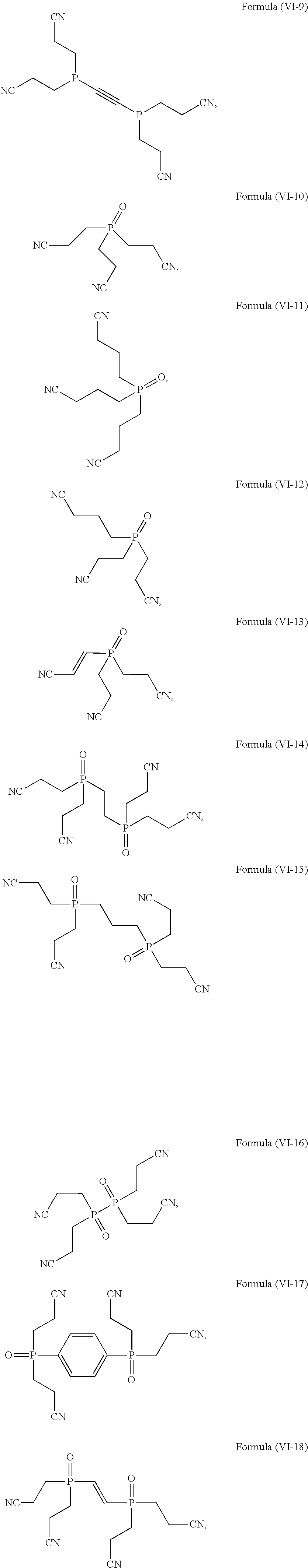

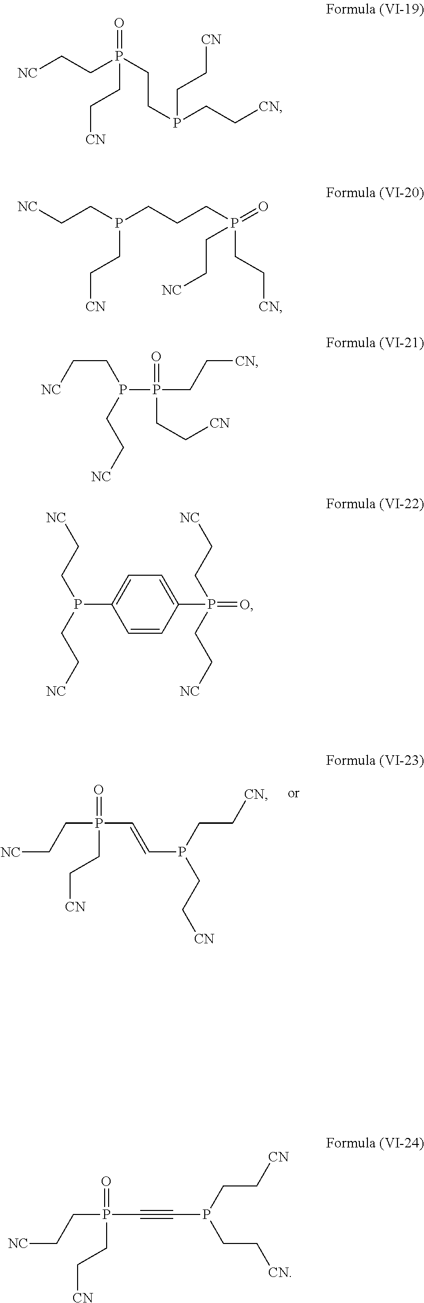

9. The secondary battery according to claim 1, wherein the electrolyte comprises a carbonate compound and a carboxylate compound; wherein based on the mass of the electrolyte, a mass percentage of the carbonate compound is F %, and a mass percentage of the carboxylate compound is G %, satisfying 8.2≤F≤24.9 and 8.2≤F+G≤41.5; and
the carbonate compound comprises at least one of ethylene carbonate, propylene carbonate, butylene carbonate, dimethyl carbonate, methyl ethyl carbonate, diethyl carbonate, dipropyl carbonate, methyl propyl carbonate, ethyl propyl carbonate, dioctyl carbonate, dipentyl carbonate, ethyl isobutyl carbonate, isopropyl methyl carbonate, di-n-butyl carbonate, diisopropyl carbonate, or propyl carbonate; and the carboxylate compound comprises at least one of methyl acetate, ethyl acetate, propyl acetate, ethyl propionate, propyl propionate, butyl propionate, or pentyl propionate.

10. The secondary battery according to claim 9, wherein 0≤G≤33.3.

11. The secondary battery according to claim 1, wherein the electrolyte comprises a lithium salt; wherein based on the mass of the electrolyte, a mass percentage of the lithium salt is H %, satisfying 8≤H≤20; and
the lithium salt comprises at least one of lithium hexafluorophosphate, lithium bis(trifluoromethanesulfonyl)imide, lithium bis(fluorosulfonyl)imide, lithium tetrafluoroborate, lithium bis(oxalato)borate, lithium difluorooxalatoborate, or lithium difluorophosphate.

12. An electronic apparatus comprising the secondary battery according to claim 1.

13. The electronic apparatus according to claim 12, wherein 0.5≤A≤3 and 45.9≤B≤75.

14. The electronic apparatus according to claim 12, wherein based on the mass of the positive electrode material layer, a mass percentage of the element cobalt is C %, satisfying 51.1≤C≤58.8.

15. The electronic apparatus according to claim 12, wherein the positive electrode active material comprises Li_{α}Co_{1-x-y}MgₓM_{y}O_{β}, wherein 0.95≤α≤1.4, 0.004≤x≤0.192, 0≤y≤0.34, 1.9≤β≤2.1, and M comprises at least one of Mn, Al, Ni, Ca, Ti, Zr, V, Cr, Fe, Cu, Zn, Rb, or Sn.

16. The electronic apparatus according to claim 12, wherein the compound represented by formula (I) comprises at least one of the following compounds: 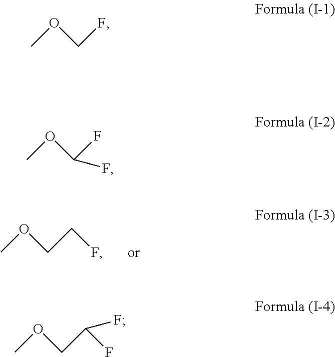
the compound represented by formula (II) comprises at least one of the following compounds: 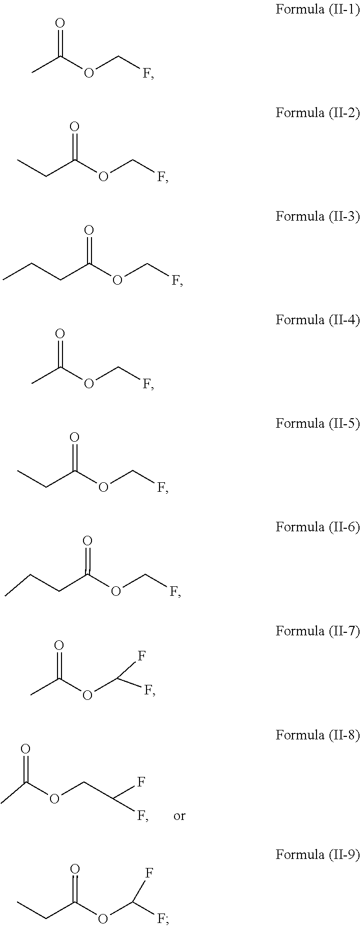
the compound represented by formula (III) comprises at least one of the following compounds: 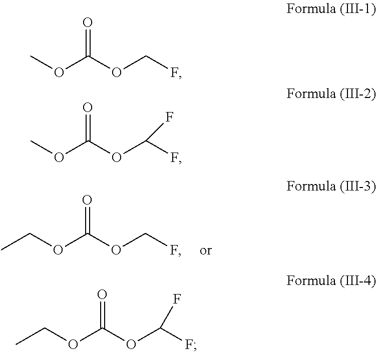
and
the compound represented by formula (IV) comprises at least one of the following compounds:

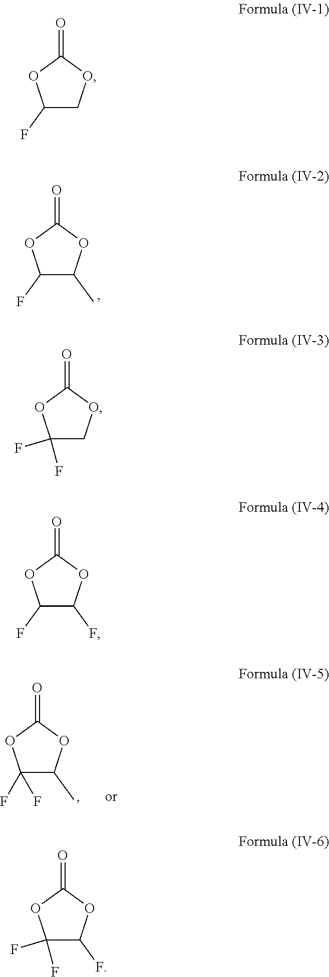

17. The electronic apparatus according to claim 12, wherein the electrolyte comprises a compound represented by formula (V): 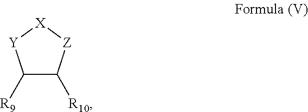
wherein X is selected from any one of 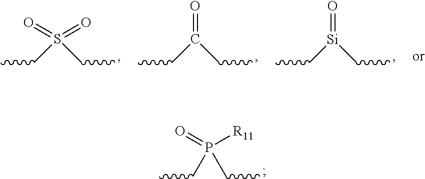 [symbol]
represents a binding site for binding to an adjacent atom; and Y and Z are each independently selected from any one of C or O;
R₉, R₁₀, and R₁₁ are each independently selected from H, substituted or unsubstituted C₁ to C₁₀ alkyl group, substituted or unsubstituted C₂ to C₁₀ alkenyl group, substituted or unsubstituted C₂ to C₁₀ alkynyl group, substituted or unsubstituted C₆ to C₁₀ aryl group, substituted or unsubstituted C₁ to C₁₀ alkoxy group, substituted or unsubstituted C₂ to C₁₀ cycloalkoxy group, substituted or unsubstituted C₂ to C₁₀ alkenyloxy group, substituted or unsubstituted C₂ to C₁₀ alkynyloxy group, substituted or unsubstituted C₆ to C₁₀ aryloxy group, substituted or unsubstituted C₁ to C₁₀ carboxyl group, substituted or unsubstituted C₁ to C₁₀ carbonyl group, substituted or unsubstituted C₁ to C₁₀ cyano group, substituted or unsubstituted C₁ to C₁₀ amino group, substituted or unsubstituted C₂ to C₁₀ carbonate group, substituted or unsubstituted C₁ to C₁₀ sulfate group, substituted or unsubstituted C₁ to C₁₀ sulfite group, substituted or unsubstituted C₁ to C₁₀ borate group, substituted or unsubstituted C₁ to C₁₀ silane group, substituted or unsubstituted C₁ to C₁₀ siloxane group, or substituted or unsubstituted C₁ to C₁₀ phosphate group; and when substituted, the substituents of these groups are each independently selected from at least one of halogen atom or cyano group; and
based on the mass of the electrolyte, a mass percentage of the compound represented by formula (V) is D %, satisfying 0.05≤D≤5.

18. The electronic apparatus according to claim 17, wherein the compound represented by formula (V) comprises at least one of the following compounds:

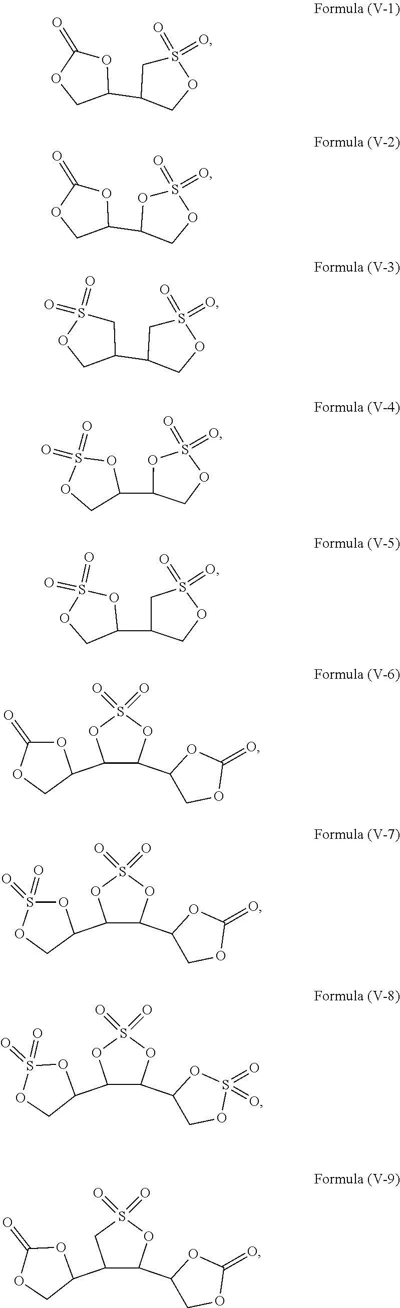

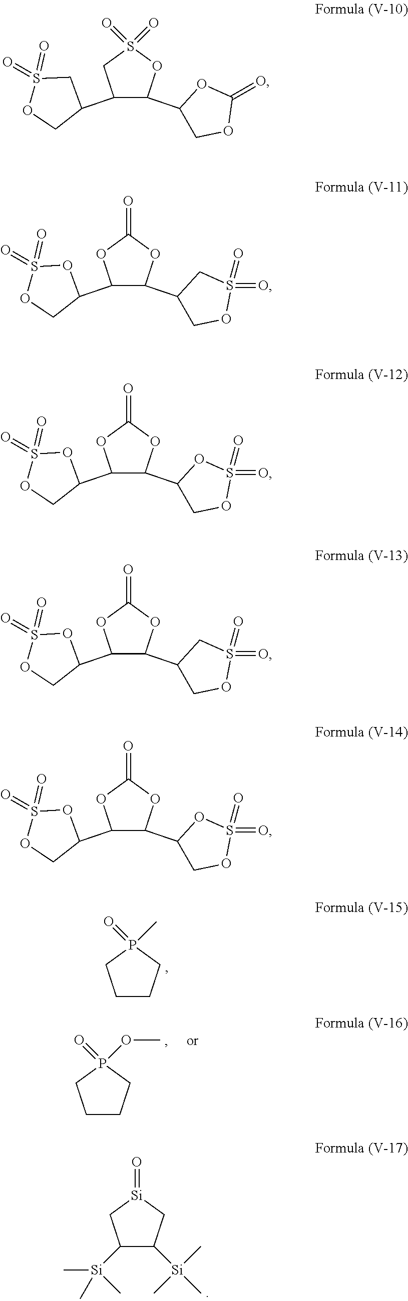

19. The electronic apparatus according to claim 12, wherein the electrolyte comprises a nitrile compound; and based on the mass of the electrolyte, a percentage of the nitrile compound is E %, satisfying 0.1≤E≤8; wherein
the nitrile compound comprises malononitrile, succinonitrile, glutaronitrile, adiponitrile, octanedinitrile, terephthalonitrile, tetradecanedinitrile, azomalononitrile, methylene pentanedinitrile, pentenenitrile, 1,3,5-benzenetricarbonitrile, 2,4,6-trifluorobenzene-1,3,5-tricarbonitrile, 2-bromobenzene-1,3,5-tricarbonitrile, 1,3,6-hexanetricarbonitrile, 1,2,3-propanetricarbonitrile, 1,3,5-pentanetricarbonitrile, 1,2,6-hexanetricarbonitrile, or at least one of compounds represented by the following formulas (VI):

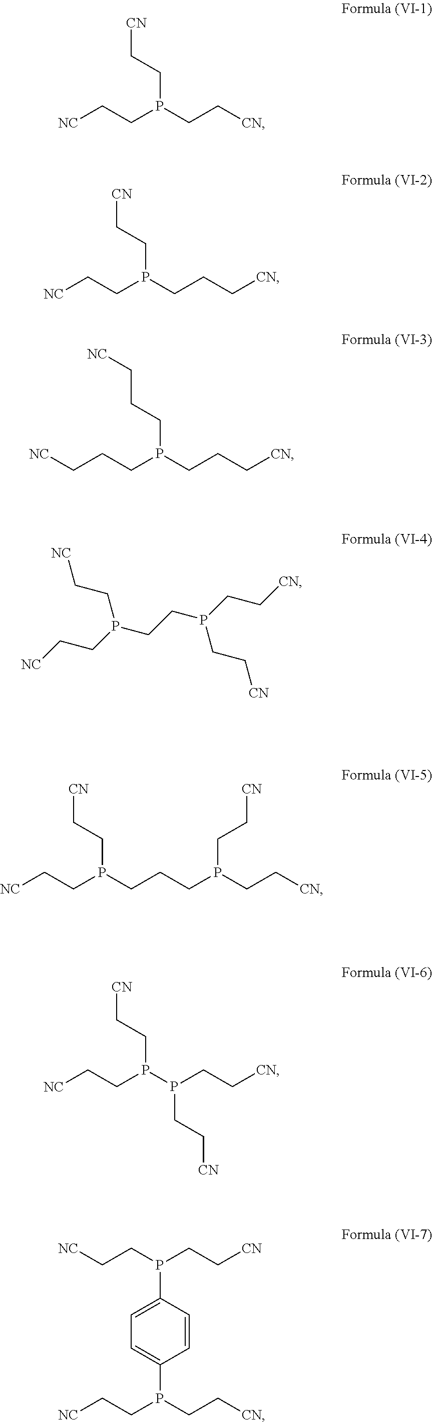

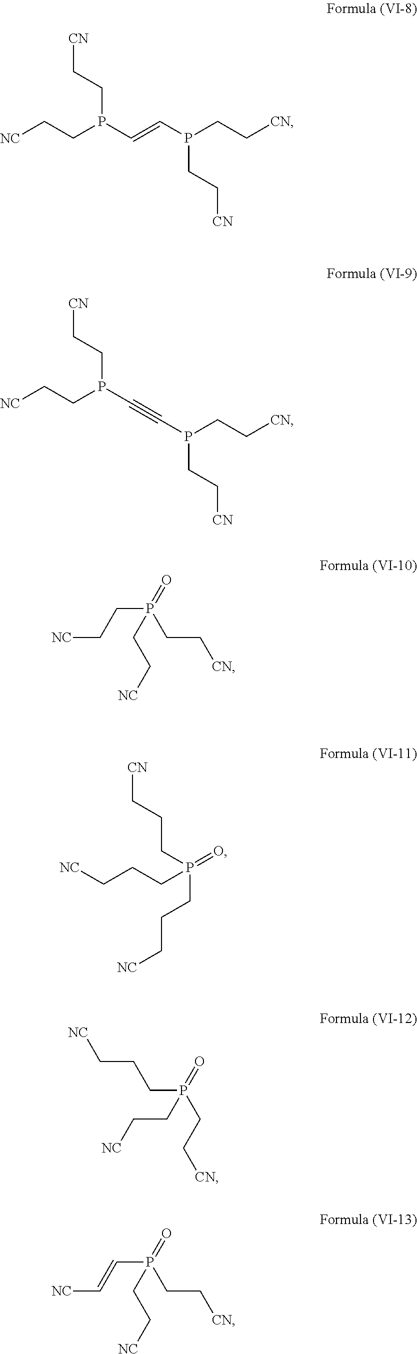 [SMILES: N#CCCP(/C=C/P(CCC#N)CCC#N)CCC#N ; N#CCCP(C#CP(CCC#N)CCC#N)CCC#N ; N#CCCP(=O)(CCC#N)CCC#N ; N#CCCCP(=O)(CCCC#N)CCCC#N ; N#CCCCP(=O)(CCC#N)CCC#N ; N#C/C=C/P(=O)(CCC#N)CCC#N]

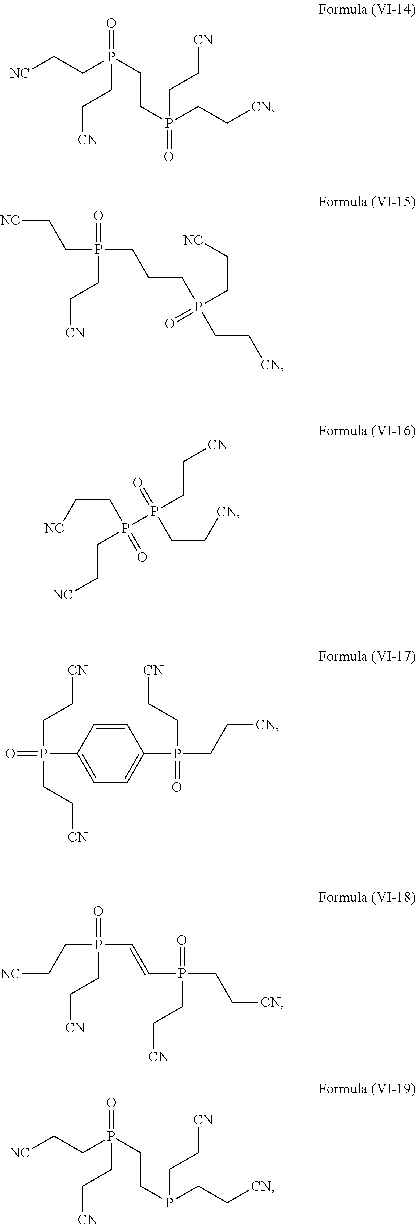 [SMILES: N#CCCP(=O)(CCC#N)CCP(=O)(CCC#N)CCC#N ; N#CCCP(=O)(CCC#N)CCCP(=O)(CCC#N)CCC#N ; N#CCCP(=O)(CCC#N)P(=O)(CCC#N)CCC#N ; N#CCCP(=O)(CCC#N)c1ccc(P(=O)(CCC#N)CCC#N)cc1 ; N#CCCP(=O)(/C=C/P(=O)(CCC#N)CCC#N)CCC#N ; N#CCCP(CCC#N)CCP(=O)(CCC#N)CCC#N]

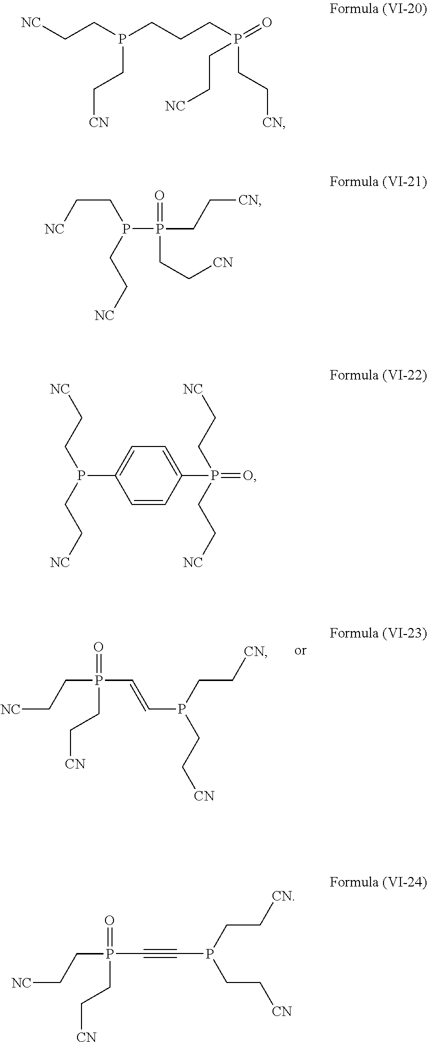 [SMILES: N#CCCP(CCC#N)CCCP(=O)(CCC#N)CCC#N ; N#CCCP(CCC#N)P(=O)(CCC#N)CCC#N ; N#CCCP(CCC#N)c1ccc(P(=O)(CCC#N)CCC#N)cc1 ; N#CCCP(/C=C/P(=O)(CCC#N)CCC#N)CCC#N ; "or" ; N#CCCP(C#CP(=O)(CCC#N)CCC#N)CCC#N]

20. The electronic apparatus according to claim 12, wherein the electrolyte comprises a carbonate compound and a carboxylate compound; wherein based on the mass of the electrolyte, a mass percentage of the carbonate compound is F %, and a mass percentage of the carboxylate compound is G %, satisfying 0≤G≤33.3, 8.2≤F≤24.9 and 8.2≤F+G≤41.5; and
the carbonate compound comprises at least one of ethylene carbonate, propylene carbonate, butylene carbonate, dimethyl carbonate, methyl ethyl carbonate, diethyl carbonate, dipropyl carbonate, methyl propyl carbonate, ethyl propyl carbonate, dioctyl carbonate, dipentyl carbonate, ethyl isobutyl carbonate, isopropyl methyl carbonate, di-n-butyl carbonate, diisopropyl carbonate, or propyl carbonate; and the carboxylate compound comprises at least one of methyl acetate, ethyl acetate, propyl acetate, ethyl propionate, propyl propionate, butyl propionate, or pentyl propionate.
